(19) United States
(12) Patent Application Publication
(10) Pub. No.: US 2024/0011708 A1
(43) Pub. Date: Jan. 11, 2024

(54) METHOD AND APPARATUS FOR FREEZING OR THAWING MIXTURES COMPRISING WATER

(71) Applicant: RHEAVITA BV, ZWIJNAARDE (GENT) (BE)

(72) Inventors: Jozef Antonius Willen Maria CORVER, NUENEN (NL); Pieter-Jan Pierre VAN BOCKSTAL, WAREGEM (BE)

(73) Assignee: RHEAVITA BV, ZWIJNAARDE (GENT) (BE)

(21) Appl. No.: 18/035,117

(22) PCT Filed: Nov. 3, 2021
(86) PCT No.: PCT/EP2021/080545

§ 371 Date: May 3, 2023

(30) Foreign Application Priority Data
Nov. 4, 2020 (NL) 2026826

(51) Int. Cl. F26B 5/06; F26B 3/04; F26B 21/10; F26B 21/12; F26B 25/22; F26B 11/02

(52) U.S. Cl. CPC F26B 5/06; F26B 3/04; F26B 21/10; F26B 21/12; F26B 25/22; F26B 11/028

(57) ABSTRACT

The invention relates to a method for freezing injectable compositions, in particular pharmaceutical compositions. The method comprises: storing a quantity of a dispersion of an injectable composition in an aqueous dispersion medium in a vial; cooling the vial by applying cooling gas to the vial, the cooling characterized by performing at least one of (A), (B) and (C), wherein (A) is an initial cooling control scheme before nucleation has occurred in the dispersion layer, (B) is a crystallization control scheme during crystallization of the dispersion layer, and (C) is a final cooling control scheme after the dispersion layer has crystallized; and obtaining the dispersion after freezing is complete.

### TECHNICAL FIELD

This disclosure generally relates to the field of freezing and thawing mixtures, suitable for—for example—freeze-drying of products, including but not limited to injectable compositions, in particular pharmaceutical compositions, biological compositions, cosmetic compositions or medical nutritional products. In particular, the present disclosure relates to a method and apparatus for freezing mixtures comprising water. More generally, the method and apparatus is for solidification of a fluidic substance by removing heat through jetting with cold gas on the container. Additionally, the method of jetting thermally controlled gas and a similar apparatus can be used for controlled thawing of initially frozen mixtures.

### BACKGROUND

Freeze drying, also known as lyophilisation, is a technique to remove water from a composition after the composition is frozen and placed under a vacuum, such that the ice can be removed by sublimation. Sublimation is the transition of a substance directly from a solid state into a gas state, without passing through a liquid state. Freeze drying has been known for several decades and used typically on perishable material (e.g. pharmaceutical products or food products), for example to make the material more convenient for storage, distribution and/or transport.

A conventional method to execute this lyophilisation process is to place a batch of containers, each container provided with a dispersion of a composition, on hollow shelves inside a sealed chamber. With a thermal fluid flowing through the hollow shelves, the shelves are chilled which in turn reduces the temperature of the containers and the composition inside. At the end of this freezing cycle the aqueous composition is frozen as a plug at the bottom of the container, after which the pressure in the chamber is reduced and the shelves are simultaneously gradually heated to force sublimation of ice crystals formed in the frozen composition. During the sublimation process water vapour will be generated which leaves the surface of the plug situated on the bottom of the container. The ice-vapour interface, also called the sublimation front, moves slowly downward as the sublimation process progresses.

Once a substantial part of the ice crystals has been removed a porous structure of the composition remains. Commonly a secondary drying step will follow to complete the lyophilization cycle wherein residual moisture is removed from the formulation interstitial matrix by desorption with elevated temperatures and/or adapted pressures.

Focusing on the freezing step, this step is one of the steps that is considered critical for the quality of the final dried product, since the structure and morphology of the consequential dried product is established in this step. The freezing step is generally considered to consist of four separate phases. (I) First, the liquid is cooled until the product's temperature is below the crystallization point. Cooling below the crystallisation point, while no crystallisation takes place is generally named supercooling, also known as undercooling, which is the process of lowering the temperature of the liquid below its freezing point without it becoming a solid. Supercooling can take place in the presence of a seed crystal or nucleus, as long as a crystal structure cannot form around such a nucleus. (II) Next, nucleation occurs, which is the origin of a crystalline phase from the supercooled liquid. Nucleation designates the onset of crystallization. Since during crystallization, heat must be given off by the product, there is a relative temperature rise due to this exothermic nature of ice crystallization. (III) Next, during the crystallization phase, also known as the crystal growth phase, the crystal state is reached. Again, this is an exothermic process where heat is removed from the product. (IV) Finally, the solid is further cooled. In this phase, the final shape and size of the ice crystals is determined via a phenomenon called Ostwald ripening.

While the freezing step in freeze drying is considered particularly important, the actual control of all phases during freezing (I)-(IV) described above is limited in traditional shelf freeze dryers. As said, the shelves are indirectly cooled through a diathermal fluid (used as means for transferring thermal energy) which in turn cools the vials containing the product. This process is inherently slow, and the cooling of the shelves is usually limited to 1-2 degrees Celsius per minute, which greatly limits the control capabilities. Moreover, due to the method of cooling the control is limited to control of the diathermal fluid, with a very distinct linkage to the product.

With respect to controlled nucleation, several improvements have been proposed to induce nucleation in order to reduce product variability: (A) induce a rapid sequence of pulling vacuum and aeration to induce density shocks; (B) induce a fogging of small ice crystals; (C) induce a fogging of small droplets of liquid nitrogen.

All the above methods (A)-(C) first apply a low temperature just below the normal crystallization point (supercooling) and assure sufficient thermal stabilization. Then, by applying such an induction method, the variability of crystallization is greatly reduced when subsequent crystallization occurs. Yet, further improvements are aimed for.

WO 2013/036107 discloses a method of freeze-drying injectable compositions, comprising: A) storing a quantity of a dispersion or solution of an injectable composition in an aqueous dispersion or solution medium in at least one ready-to-use vial, B) rotating the vial at least for a period of time to form a dispersion or solution layer at an inner surface of a circumferential wall of the vial, C) during rotating of the vial according to step B) cooling the vial to solidify and in particular to form ice crystals at the inner surface of the circumferential wall of the vial, and D) drying the cooled composition to sublime at least a portion of the ice crystals formed in the dispersion or solution by substantially homogeneously heating the circumferential wall of the vial. Cooling and freezing of the product in vials is achieved by applying cold gas jetting to the rotating vial.

With this process the cooling of the product can be set at will between 0.5 and 100 degrees Celsius per minute. The thermal trajectory of the cooling phase of liquid and ice is controlled using non-contact temperature measurement, and control of the temperature of the cooling gas and/or the time of a certain setpoint is maintained. This solution controls the temperature trajectory of the liquid phase and crystallized water, but further improvements are sought for.

“In-Situ X-ray Imaging Of Sublimating Spin-Frozen Solutions”, Materials 2020, 13, 2953, by Goethals, W.; Vanbillemont, B.; Lammens, J.; De Beer, T.; Vervaet, C.; Boone, M. N., describes the structure of a frozen substance as processed by a spin-freeze-drying technique. The resulting product structures are visualized using micro-CT scanning technology. Some of the results after data-processing show a profile that matches with a ‘pillar’-like structure, which facilitates the escape of water vapor.

In “Mechanistic modelling of infrared mediated energy transfer during the primary drying step of a continuous freeze-drying process”, European Journal of Pharmaceutics and Biopharmaceutics 114 (2017) 11-21, by Pieter-Jan Van Bockstal et al., a mechanistic model was developed which allows computing the optimal, dynamic IR heater temperature in function of the primary drying progress and which, hence, also allows predicting the primary drying endpoint based on the applied dynamic IR heater temperature. This model is compared to experimental verification. The mechanistic model did not consider the geometric structures, such as indicated in the previously cited publication. This results in a sublimation time, which is shorter than modelled.

For the development of (new) therapies a series of treatment-steps of active pharmaceutical ingredient (API) and/or drug product formulation is necessary. Those steps involve besides freezing and crystal formation, also thawing. This thawing process is influential in the yield and efficacy of the API. This is done using immersion of containers comprising API into thermally controlled baths. Although in such baths the final temperature is suitably guaranteed, the trajectory to get there is not and dependent on several physical conditions. For example, in some cases a rapid initial temperature rise is mandatory, followed by a slow final thawing, or vice versa which cannot be realized with immersion.

For example, a method could be to quickly transfer an ampoule containing the API to a 37° C. water bath until only one or two small ice crystals, if any, remain (1-2 minutes). It is viewed as important to thaw rapidly, such as to minimize any damage to, for example, cell membranes. This method greatly increases the risk of contamination by use of the thermal bath, for example when the ampoule is immersed completely in the thermal bath, or if the ampoule is incorrectly closed.

In “The Impact of Varying Cooling and Thawing Rates on the Quality of Cryopreserved Human Peripheral Blood T Cells”, Sci Rep 9, 3417 (2019), Baboo, J., Kilbride, P., Delahaye, M. et al., the interaction between different freezing scenario's and thawing processes is determined on the survival of blood T-cells. An illustration of the different ice structures, following different freezing and thawing routes is shown. It is disclosed that when comparing the various situations with survival of the cells, depending on the initial freezing situation, the thawing may have a great impact on the survival rate of cells. This publication gives a summary of the survival success for different living organisms, comparing for example cell types, cooling rate and effect of warming rate.

In “Thermostability of Biological Systems: Fundamentals, Challenges, and Quantification”; The Open Biomedical Engineering Journal, 2011, 5, 47-73, by Xiaoming He, the fundamental aspects of freezing and thawing related to thermodynamic energy transfer are described and compared to images from practice. One illustration is taken to visualize the impact of freezing scenario's on cell structures. When the cooling rate is very low, cell dehydration dominates; when the cooling rate is high, intracellular ice formation dominates; when the cooling rate is intermediate, both intracellular ice formation and cell dehydration can occur. It must be noted that in this publication the cooling rate is taken as a parameter to study, while from a physics perspective it is the removal of heat which is the determining factor.

“Cell Size and Water Permeability as Determining Factors for Cell Viability after Freezing at Different Cooling Rates”; Applied and Environmental Microbiology, Jan. 2004, p. 268-272; DOI: 10.1128/AEM.70.1.268-272.2004, by F. Dumont et al., indicates different results in relation to cooling rates, in particular the relation of cell viability to cooling rate for different organisms. The fact that they take cooling rates as the parameter to study, is caused by the limitation of their equipment: only the cooling bath temperature could be monitored and controlled.

Finally, for the generation of cold gas used in the freeze-drying process to change the temperature of the product, it is necessary to cool such gas using e.g. liquid nitrogen and a heat exchanger. This may lead to spoilage of clean and cold gas. Both from an environmental standpoint and a cost standpoint, this is unwanted.

It is therefore an object of the invention to solve the abovementioned problems relating to freezing, freeze-drying, and thawing, and to improve methods of freezing, freeze-drying and thawing thus further.

### DESCRIPTION OF THE INVENTION

To address one or more of the above discussed drawbacks of the prior art, the present invention provides a method for changing the phase of a compositions, in particular pharmaceutical compositions, comprising:
storing a quantity of the composition in a vial;
changing the phase of the composition in the vial by applying thermal gas to the vial; and
wherein changing the phase of the composition comprises freezing or thawing the composition, and wherein the thermal gas is respectively a cooling gas or a heating gas;
wherein changing the phase of the composition is characterized by performing at least one of (A), (B) (C), wherein (A) is an initial temperature change control scheme performed before entering a phase wherein the crystallization amount of the composition changes; (B) is a crystallization change control scheme during a phase wherein the crystallization amount of the composition changes; (C) is a final temperature change control scheme performed until the composition reaches its final temperature;
obtaining the composition after the change in phase is complete;
wherein the initial temperature change control scheme (A) comprises:
(I) performing an initial measurement on the vial and/or the composition to determine whether the phase wherein the crystallization amount of the composition changes has started;
(II) controlling the temperature and/or flow rate of the thermal gas such that the temperature of the vial and/or the composition is in accordance with a pre-determined initial temperature evolution over time; and
repeating steps (I) and (II) until the initial measurement determines that the phase wherein the crystallization amount of the composition changes has started;
wherein the crystallization change control scheme (B) comprises:
(I) performing a crystallization-change measurement on the vial and/or the composition to determine whether there is no longer a change in the crystallization amount in the composition;
(II) controlling the temperature and/or flowrate of the thermal gas such that the temperature of the vial and/or the composition is in accordance with a pre-determined crystallization-change temperature evolution over time;
repeating steps (I) and (II) until there is no longer a change in the crystallization amount in the composition; and
wherein the final temperature change control scheme (C) comprises:
(I) controlling the temperature and/or flow rate of the thermal gas such that the temperature of the vial and/or the composition is in accordance with a pre-determined final temperature evolution over time;
(II) performing a final temperature measurement on the vial and/or the composition to determine whether the vial and/or the composition has reached its pre-determined final temperature; and
repeating steps (I) and (II) until the final temperature measurement determines that the vial and/or the composition has reached its pre-determined final temperature.

The method according to the invention, provides suitable measures to control the crucial freezing process. The invention furthermore provides an apparatus suitable for such process.

The present invention furthermore provides methods to improve cell survival after freezing.

The present invention provides for a method for freezing injectable compositions, in particular pharmaceutical compositions, comprising: storing a quantity of a dispersion of an injectable composition in an aqueous dispersion medium in a vial; rotating the vial at least for a period of time to form a dispersion layer at an inner surface of a circumferential wall of the vial; cooling the vial by applying cooling gas to the rotating vial during rotating of the vial, the cooling characterized by performing at least one of (A), (B) and (C), wherein (A) is an initial cooling control scheme before nucleation has occurred in the dispersion layer, (B) is a crystallization control scheme during crystallization of the dispersion layer, and (C) is a final cooling control scheme after the dispersion layer has crystallized; wherein the initial cooling control scheme (A) comprises: (I) performing a nucleation measurement on the vial and/or the dispersion layer to determine whether nucleation has occurred in the dispersion layer; (II) controlling the temperature and/or flow rate of the cooling gas such that the temperature of the vial and/or the dispersion layer is in accordance with a pre-determined temperature evolution over time; and repeating steps (I) and (II) until the nucleation measurement determines that nucleation has occurred in the dispersion layer; wherein the crystallization control scheme (B) comprises: (I) performing a crystallization measurement on the vial and/or the dispersion layer to determine whether crystallization has finished in the dispersion layer; (II) controlling the temperature and/or flowrate of the cooling gas such that the temperature of the vial and/or the dispersion layer is in accordance with a pre-determined initial cooling temperature evolution over time; (III) waiting a pre-determined amount of time; and repeating steps (I)-(III) until the crystallization measurement determines that crystallization has finished in the dispersion layer; and wherein the final cooling control scheme (C) comprises: (I) controlling the temperature and/or flow rate of the cooling gas such that the temperature of the vial and/or the dispersion layer is in accordance with a pre-determined final cooling temperature evolution over time; (II) performing a final temperature measurement on the vial and/or the dispersion layer to determine whether the vial and/or the dispersion layer has reached its pre-determined final temperature; and repeating steps (I) and (II) until the final temperature measurement determines that the vial and/or the dispersion layer has reached its pre-determined final temperature.

In each of the control schemes, one can wait a pre-determined amount of time before repeating steps (I) and (II). This can be a control parameter, indicating the amount of heat that was exchanged between the gas and the vial for a particular temperature and flowrate setting.

The phrase ‘dispersion of an injectable composition in an aqueous dispersion medium’ is meant to comprise any mixture of an injectable composition which is admixed with an aqueous medium. The injectable composition may be dissolved (in the sense of mixed on molecular level), dispersed (in the sense of solids in a fluid) or emulsified (in the sense of liquid particles in an another liquid) in the aqueous medium. Many injectable compositions are known in the art, and it may be difficult to describe the mixture as emulsion, dispersion (in a strict sense), or solution. The present invention is not depending on the specific form of the mixture of the injectable composition and the aqueous medium. The mixtures that need to be frozen (generally before freeze drying) in particular comprise proteins like antibodies, receptor antagonists, receptor agonists and the like. In another embodiment, the mixture comprises whole cells. Next to the protein, cells, or the like, often excipients are present that are not removed during a freeze-drying process. Thus, the injectable composition is meant to comprise any component that remains in a freeze-drying composition.

In case the frozen composition is used for thawing, no or little component is removed. Most commonly, this is applicable to whole cells that are frozen, and thawed. Current survival rates of for example CAR-T cells is about 10% after a freezing and thawing cycle. Hence, a process that allows higher survival rates is much wanted. The present invention allows substantial higher survival rates.

A dispersion is a mixture of an active pharmaceutical ingredient (API, also called a substance), together with possible excipients like a salt, a buffer, cryoprotectant or lyoprotectant, and a possible solvent such as water. In some cases, co-solvents such as ethanol may be applied to facilitate dissolving the API.

In the process of freezing whole cells useful excipients are additives that diffuse into the cells, causing vitrification, thereby preventing ice crystals in the cells. Other protectants influence the osmolality. Suitable cryoprotectants include DMSO, glycerol, propanediol, dimethyl hydrazine, sucrose, trehalose, mannitol, lactose, polyvinylpyrrolidone.

In the method for freezing injectable compositions, preferably after crystallization has finished in the dispersion layer, the flowrate of the cooling gas is changed to a pre-determined value.

Preferably, in the method for freezing injectable compositions, the initial cooling control scheme further comprises inducing condensation nuclei, inducing artificial density gradients in the composition by acoustic waves or pressure waves, or inducing thermal shocks.

Preferably, in the method for freezing injectable compositions, acoustic waves or pressure waves are produced by inducing rotation variations, in order to initiate condensation nuclei.

In a preferred embodiment, thermal shocks are induced by variations in the temperature or flow rate of the cooling gas.

In a preferred embodiment, the nucleation measurement, the crystallization measurement, the final temperature measurement and/or the temperature measurements are performed using a thermal infrared camera which detects IR radiation of the vial, wherein the IR radiation of the vial is converted into temperature information of the dispersion layer using an image processing module.

Preferably, the temperature information is used together with a mathematical model to determine in real-time the properties of the dispersion layer.

In a preferred embodiment, a process is applied that combines at least two steps of (A), (B) and (C), such as a process that applies A and B, or A and C, or B and C. It is even more preferred to apply a process in which all three steps A, B and C are applied.

The freezing step results in a more defined frozen mixture than the frozen mixtures in the prior art. The improved defined parameters comprise crystal size, crystal boundaries, whole cell survival and the like. This is useful for a number of reasons. The utility of the improvement may vary depending on the use. For example, if antibodies are frozen for freeze drying, a well-defined frozen mixture can shorten the necessary time for (freeze) drying substantially, as the crystal size may allow cracks in the frozen layers, allowing fast sublimation of water. In case of whole cells, the major improvement may be the improved survival. Current standards of freezing for example T-cells and thawing the same allows only about 10% cell survival. With the process of the present invention, substantial higher survival rates are possible.

Thus, the present invention for freezing dispersions, allows improved freeze-drying processes, and improved freezing/thawing processes.

The present invention is therefore specifically preferred for a method for freeze-drying injectable compositions, in particular pharmaceutical compositions, wherein the freezing is performed as described above, whereafter drying is performed while applying vacuum. The drying step in freeze drying can be a conventional vacuum chamber but is preferably a controlled drying process as described in WO 2013/036107.

The present invention furthermore relates to a freezing apparatus for freezing injectable compositions, in particular pharmaceutical compositions, wherein the freezing apparatus comprises: a freezing chamber comprising rotation means for one or more vials, wherein one or more vials containing a quantity of a dispersion of an injectable composition in an aqueous dispersion medium can be rotated at least for a period of time to form a dispersion layer at an inner surface of a circumferential wall of the vial, and comprising a cooling gas system for applying cooling gas to the rotating vial during rotating of the vial such that the vial is cooled; an exhaust from the freezing chamber through which used cooling gas exits the freezing chamber; a heat exchange element at least partially surrounding the freezing chamber, wherein the heat exchange element is in thermal contact with the freezing chamber, wherein the heat exchange element cools the freezing chamber by using the used cooling gas.

Another preferred embodiment of the invention relates to a freezing apparatus for freezing injectable compositions, in particular pharmaceutical compositions, wherein the freezing apparatus comprises: a freezing chamber comprising rotation means for one or more vials, wherein one or more vials containing a quantity of a dispersion of an injectable composition in an aqueous dispersion medium can be rotated at least for a period of time to form a dispersion layer at an inner surface of a circumferential wall of the vial, and comprising a cooling gas system for applying cooling gas to the rotating vial during rotating of the vial such that the vial is cooled; an exhaust from the freezing chamber through which used cooling gas exits the freezing chamber; wherein the freezing apparatus comprises control means, for controlling the freezing process as described above. The present invention specifically relates to a freezing apparatus comprising controlling means for any of, and the combined controlled means as described above.

Preferably, in the freezing apparatus, the used cooling gas is able to flow through the heat exchange element, such as to cool the freezing chamber.

Preferably, in the freezing apparatus, the heat exchange element is formed by helically wound channels and/or meandering channels surrounding the freezing chamber, through which the used cooling gas can flow.

Preferably, in the freezing apparatus, the heat exchange element is positioned in a double-wall structure surrounding the freezing chamber.

Preferably, in the freezing apparatus, the freezing apparatus comprises control means, for controlling the freezing process as described above.

In a further preferred embodiment, the invention relates to a freeze-drying system for freeze-drying injectable compositions, in particular pharmaceutical compositions, wherein the freeze-drying system comprises: a freezing apparatus as described above; an annealing apparatus and/or a sublimation apparatus, wherein the annealing apparatus and/or the sublimation apparatus comprise a respective annealing chamber and a sublimation chamber, wherein the annealing apparatus and/or the sublimation apparatus comprise a respective heat exchange element in thermal contact with the annealing chamber and the sublimation chamber respectively, wherein the respective heat exchange elements cool the annealing chamber and/or the sublimation chamber by using the used cooling gas.

In a further preferred embodiment, the invention provides a freezing apparatus for freezing injectable compositions, in particular pharmaceutical compositions, the freezing apparatus for use in a freeze-drying process, wherein the freezing apparatus comprises: a freezing chamber comprising rotation means wherein one or more vials containing a quantity of a dispersion of an injectable composition in an aqueous dispersion medium are rotated at least for a period of time to form a dispersion layer at an inner surface of a circumferential wall of the vial, and a cooling gas system for applying cooling gas at a cooling temperature to the rotating vial during rotating of the vial such that the vial is cooled; an exhaust from the freezing chamber through which used cooling gas exits the freezing chamber; wherein the cooling gas system comprises a pre-cooling system where the gas is pre-cooled before cooling of the gas to the cooling temperature is performed; wherein the pre-cooling system comprises a heat exchange element in thermal contact with the gas to be pre-cooled, wherein the heat exchange element cools the gas to be pre-cooled by using the used cooling gas.

Preferably, the heat exchange element is formed by a first piping system through which the gas to be pre-cooled flows and a second piping system through which the used cooling gas flows, the first piping system and the second piping system being in thermal contact with each other.

In a further preferred embodiment, the invention provides for a freezing apparatus for freezing injectable compositions, in particular pharmaceutical compositions, wherein the freezing apparatus comprises: a freezing chamber comprising rotation means wherein one or more vials containing a quantity of a dispersion of an injectable composition in an aqueous dispersion medium are rotated at least for a period of time to form a dispersion layer at an inner surface of a circumferential wall of the vial, and a cooling gas system for applying cooling gas at a cooling temperature to the rotating vial during rotating of the vial such that the vial is cooled; an exhaust from the freezing chamber through which used cooling gas exits the freezing chamber; wherein the cooling gas system comprises a cooling system where the gas is cooled to the cooling temperature; wherein the cooling system comprises a compressor and a heat exchange element in thermal contact with the compressor, wherein the heat exchange element cools the compressor by using the used cooling gas means for measuring the temperature of the vial during at least a certain time of the freezing process, control mechanisms for influencing the flow rate and/or temperature of the cooling gas, to adjust the cooling rate during at least a part of the freezing process.

### BRIEF DESCRIPTION OF DRAWINGS

Embodiments will now be described, by way of example only, with reference to the accompanying schematic drawings in which corresponding reference symbols indicate corresponding parts, and in which:

FIG. 1 illustrates an exemplary freezing cycle;

FIGS. 2A-2B show two ways of freezing a substance in a container or vial known from the art;

FIGS. 3A-B show two embodiments for the freezing process using the flow of cold gas, as known from the art;

FIG. 4 illustrates that a thermal IR camera can be used to “measure” the temperature of the outside surface of the container wall;

FIG. 5 is a variant of the arrangement of FIG. 4, showing that the thermal IR camera 61 can also be mounted in a different manner generally independent of the position of the vial;

FIG. 6 shows a possible contactless measurement, for example using the thermal IR camera, of an exemplary freezing-cycle;

FIG. 7A-7C show a control scheme to be used by a control system to adaptively control the temperature and gas flow rate of the cold gas during (sub-)cooling, nucleation and/or crystallization;

FIGS. 8-10 schematically show respectively a first, second and third alternative for a gas cooling system;

FIG. 11 schematically shows a spin freeze-drying system, where exhaust gas from the freezing step is reused to condition the double-walled chambers;

FIGS. 12A and 12B schematically show a cross-section of a double wall structure;

FIG. 13 schematically shows a first heat exchanger which can be used for pre-cooling gas to be used as cooling gas in a spin freeze-dryer;

FIG. 14 schematically shows a second heat exchanger which can be used for pre-cooling gas to be used as cooling gas in a spin freeze-dryer;

FIG. 15 illustrates an exemplary thawing cycle;

FIGS. 16A-16E show a control scheme to be used by a control system to adaptively control the temperature and gas flow rate of the cold gas during thawing of a frozen product;

FIG. 17 schematically shows a gas cooling/heating system, which is an adaptation of the gas cooling system shown in FIG. 8;

FIG. 18 schematically shows a gas heating system;

FIG. 19 schematically shows a thawing system, where exhaust gas from the thawing cycle is reused to condition the double-walled chambers of the thawing chamber;

FIG. 20 shows an exemplary vial that can be used in the present invention;

FIG. 21 shows a corresponding table to the vial shown in FIG. 20, comprising dimensions for a vial with a particular R-value (Rohr-value);

FIG. 22A shows experimental results of contactless measurement of a freezing cycle using the present invention at a cooling rate of 10° C./min and a crystallization rate of 3.815 W;

FIG. 22B shows experimental results of contactless measurement of a freezing cycle using the present invention at a cooling rate of 10° C./min and a crystallization rate of 7.630 W.

The figures are intended for illustrative purposes only, and do not serve as restriction of the scope or the protection as laid down by the claims.

### DESCRIPTION OF EMBODIMENTS

Hereinafter, certain embodiments will be described in further detail. It should be appreciated, however, that these embodiments may not be construed as limiting the scope of protection for the present disclosure.

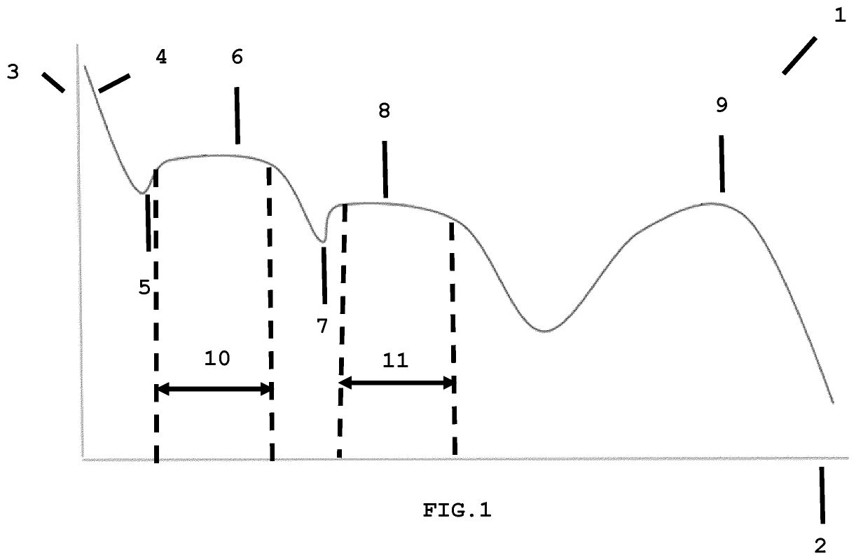

FIG. 1 illustrates an exemplary freezing cycle 1. The horizontal axis 2 indicates the time, while the vertical axis 3 is related to the dispersion temperature in the vial. For pure water, the freezing point would be zero degrees Celsius. For solutions, the freezing or solidification point would be below this temperature. In absence of sufficient crystallization seeds (which often is the case in pharmaceutical environments with low numbers of stray particles) further sub-cooling occurs. The composition can thus remain liquid below the physical freezing temperature.

Reference numeral 4 indicates the cooling of the liquid composition. At a certain point 5, the onset of ice-crystals occurs, and ice formation starts. Since this is an exothermal process, the temperature of the product will rise. During ice crystallization 6 over ice crystallization time 10, the product remains almost thermally constant. In practice at a constant energy decrease, less and less water is converted into ice; hence in practice the product will not remain exactly thermally constant and show a slow decrease.

Another nucleation point 7 occurs when an excipient starts to crystallize. In this case as well, the temperature will rise due to the exothermic nature of this process. After this, a crystallization phase 8 will occur over excipient crystallization time 11. It could happen that no such excipient nucleation and crystallization occur in a particular product, or that more than one such excipient nucleation and crystallization occurs. This depends on the chemical and physical composition of the product to be freeze-dried.

The length of both the ice crystallization time 10, as the excipient crystallization time 11 can be controlled, as will be further explained below. By controlling the time length of these crystallization phases, the structure formation of the crystal structures can be controlled to a higher degree.

After further cooling, annealing 9 can occur to enlarge the size of the ice crystals or to optimize the crystallization shape of the excipients. The enlargement of the size of the ice crystals can be important to optimize the sublimation process that follows. Optimizing the crystallization shape of the excipients can be important to avoid undesired polymorphs of the excipient, for example hemi-hydrates when using mannitol.

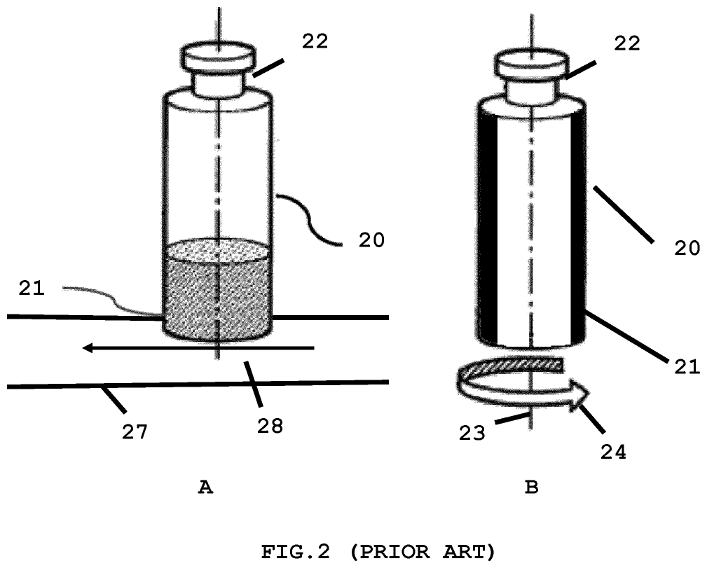

FIG. 2 shows two ways of freezing a substance in a container or vial, known in the art.

FIG. 2A shows an example of a container 20 comprising a substance 21 that is frozen while the container is kept stationary in an upright position, in which case the frozen product will be located at the bottom side of the container.

FIG. 2B shows an example of a container 20 comprising a substance 21 that is frozen while the container is being rotated around its longitudinal axis, such that the substance forms a layer, for example a relatively thin layer or a spread layer at an inner surface of a circumferential wall of the container due to centrifugal forces. In the prior art, typically a rotation speed of at least about 4000 RPM is used in order to obtain a layer having a constant thickness.

Focusing on spin freeze-drying, the vial 21 rotates with respect to axis 23 in a direction as indicated by arrow 24. Because the vial 21 rotates with a high rotational speed, for example 4000 rounds per minute, the liquid is pushed against the side walls of the vial 21 and forms a liquid dispersion with substantially uniform thickness. Subsequently, the liquid dispersion freezes with this uniform thickness.

In this example, the axis of rotation is oriented vertically, but any other orientation of the axis of rotation can be used, like for example horizontal.

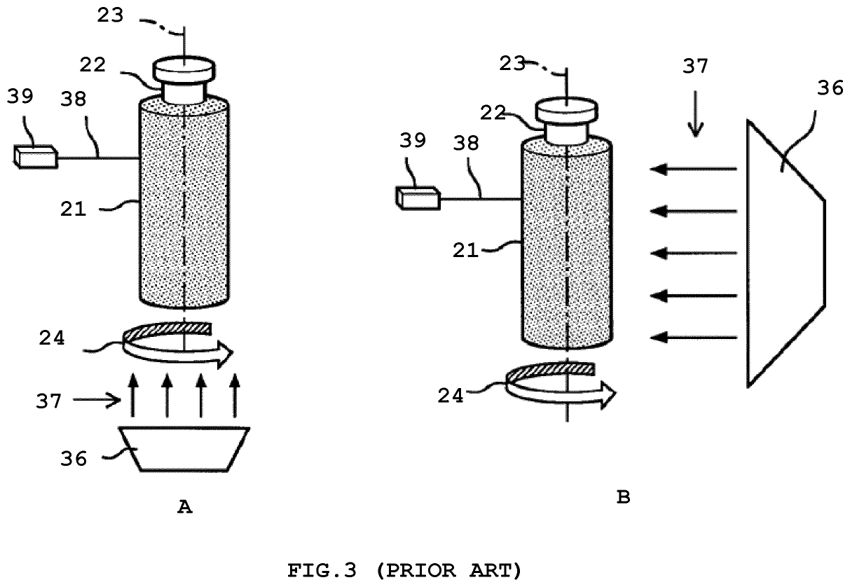

In FIG. 3 two embodiments for the freezing process with the flow of cold gas 37 are illustrated. In FIG. 3A the flow of gas 37 is in a radial direction, in FIG. 3B this occurs in an axial direction. The flow of cold gas 37 is supplied by the system 36. Through an optical system 39 which detects electromagnetic radiation in the infrared or far-infrared range 38, the condition of the freezing shell is measured.

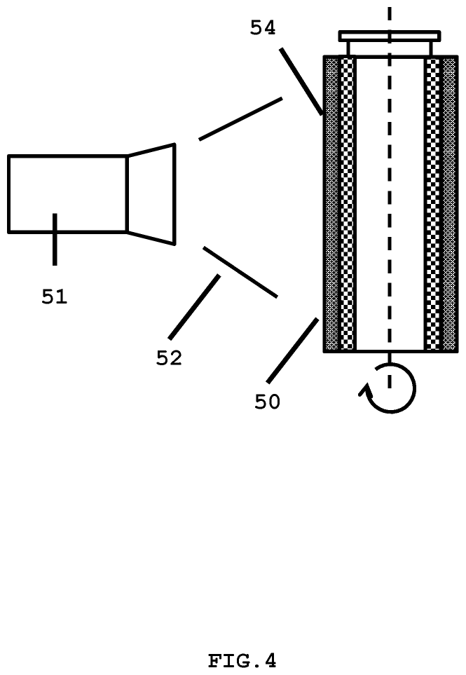

FIG. 4 illustrates that a thermal IR camera 41 can be used to “measure” the temperature of the outside surface of the container wall. The camera does not detect the temperature itself but detects IR radiation, which can be converted into temperature information using an image processing module. It is important to realize that unlike a normal camera capturing visual light, the thermal IR camera does not really “look inside” the container 40, even when the container is made of glass, hence cannot “readily see” the position of for example the crystallization front as it moves. It is noted in this respect that IR transmission through for example borosilicate glass is not exactly zero, but effective transmission is typically lower than 10%. In the present invention, it is assumed that the thermal IR camera 41 measures the temperature at the outside surface of the container 40.

In fact, this is one of the reasons why it is not straightforward to use a thermal IR camera for determining the temperature of the product inside the container, especially since the camera is arranged to capture a thermal IR image of the outer surface of the circumferential container wall 44, rather than being directed to the product inside the container itself. This is an important difference with some prior art methods where a thermal IR camera is also used for obtaining temperature information, but where the camera is oriented towards the product itself, rather than to the outside wall 44 of the container. In other words, in embodiments of the present invention, it is not required that the product inside the container lies in the field of view 42 of the camera.

The thermal image captured by the thermal IR camera, or rather the thermal information extracted from said thermal image, can be used together with a mathematical model to “monitor” in real-time the progress of the freeze-drying.

The mechanistic model to derive from the glass temperature of the vial containing a composition information on a crystallization front in the composition uses as input parameters for example the thermal properties of the ice, thermal properties of the specific glass used, thermal properties of the used cooling gas and thermal properties of the water. Measurements are performed on the temperature of the glass, flow conditions of the cooling gas and the temperature of the cooling gas and these are used as input for the mechanistic model to calculate with.

The heat transfer properties of the flowing gas are determined, using equations and relations known from fluid dynamics. Next, a relation between the temperature difference of the cooling gas and glass of the vial, and flow conditions of the gas are determined. From this, an amount of energy transferred per time (the amount of power transferred by the cooling gas) such that it can be determined how much water has been converted into ice at a particular time. Because of the concentricity of the composition caused by the rotating cylinder, it can thus be determined what the position is of the crystallization front at a particular time. Finally, from this it can be determined what the temperature of the crystallization front is.

As the position of the crystallization front changes, the heat transfer to the cooling gas from the vial also changes, such that the power of the cooling gas should be dynamically altered in a way which corresponds to the changing heat transfer.

In the case another material than glass for the vial is used, the mathematical model needs to be altered accordingly.

Moreover, rather than merely observing what is happening, the mathematical model can also be used to dynamically control the freezing process more efficiently, but importantly, without compromising the quality of the product at any time, as will become clear further.

The transition from cooling, in case of freezing, or heating, in case of thawing, to a physical phase transition, crystallization or melting, respectively can be determined using the information from the thermal measurement using, for example, the IR camera.

The slope of the curve representing temperature versus time, indicates a rapid change. So, by determining the value of the change in temperature divided by the change in time (slope), in a continuous way, the change of this time-derivative indicates a change in process. For the onset of freezing (nucleation), there are two moments: when the negative slope changes into a positive value, this indicates the onset of nucleation; when this positive slope further changes into a small negative slope again, this indicates the further onset of crystallization. At the end of crystallization, this small negative slope changes into a larger negative slope, indicating the finalization of crystallization and further cooling of the crystallized substance. The similar description is valid for subsequent phase transitions, such as crystallization of excipients.

For thawing, a similar approach can be applied. When the positive slope is suddenly reduced, the de-crystallization is happening. When this phase is finished, the slope will increase, until a next phase transitions happens (for example, melting of ice). This phase transition is finished when the slope is reaching a higher value.

By specifying the value which correspond to the indicated moments of change, the system will use this to adaptively set the control parameters for the next phase.

It is known in the art, how image data obtained from a thermal camera can be converted into accurate temperature information, which therefore need not be explained in more detail here. Suffice it to say that this can be achieved for example by proper calibration, and/or by correlating the thermal image data with known temperature information, e.g. with temperature information obtained using other means such as Ptl00 probes and/or thermocouples, or other temperature sensing means. The calculations typically involve considering thermal coefficients such as a reflection coefficient and/or an emission coefficient of the materials and their surfaces.

In an alternative embodiment, structural information on the formation of ice crystals in the composition during cooling and freezing can be monitored using an optical sensor comprising a light source configured to emit light in the near infrared range (0.75-1.4 mm), but preferably electromagnetic radiation in the (sub) Terahertz range (300 GHz-10 THz) is applied. Terahertz radiation facilitates the discrimination between different polymorphs of crystalline structures. Using this monitoring instrument which may be applied to each individual vial, the finalization of the freezing step and the morphological structure of the crystals may be determined, thereby optimizing the duration of this step. The optical sensor is preferably positioned in such a manner with respect to the vial that the dispersion layer can be measured. In another preferred embodiment, Raman spectroscopy is used, to determine vibrational modes of the molecules comprised in the composition. Depending on the measurement technique, a laser in the visible, near infrared, or near ultraviolet range can be used as a light source, although X-rays can also be used. The laser light can interact with molecular vibrations, phonons or other excitations in the system, resulting in the energy of the laser photons being shifted up or down. The shift in energy gives information about the vibrational modes in the system and thus about the state of the system. These vibrational modes can be detected by acquiring spectra, which may be characterized by using multivariate analysis techniques, such as Principal Components Analysis.

In a preferred embodiment, the temperature and flowrate of the gas is controlled on the basis of a temperature measurement, in particular an IR measurement, for example using the thermal IR camera. In a preferred embodiment, a measurement relating to the structure of the composition in the vial (e.g. nucleation, crystallization, de-crystallization, melting) is done using spectroscopy techniques as described above. These measuring methods can be combined, for the gas flowrate and temperature to be controlled, together with determining the structure information of the composition. As explained further below, the structure information of the composition can indicate that a certain control point is reached, and that a particular control scheme can end, or another control scheme can begin. In this way, the freezing (and thawing process) as described in this invention can be controlled.

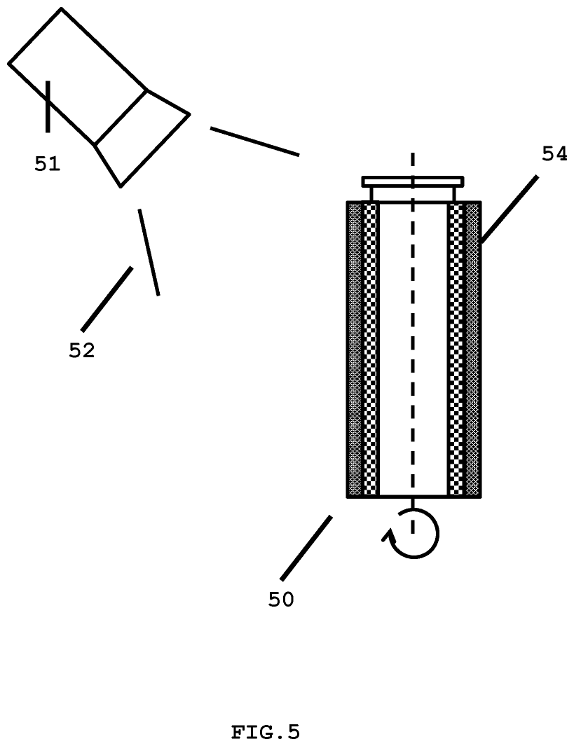

FIG. 5 is a variant of the arrangement of FIG. 4, showing that the thermal IR camera 51 can also be mounted in a tilted position, and can also be mounted at a higher or a lower position relative to the container 50, but of course this is only an example and other positions than the one being explicitly. The method can be applied for example for cylindrical containers which contain (partially) frozen products substantially in the form of a thin layer against an inner wall of the container, in which case the at least one thermal IR camera is preferably arranged to capture a major portion of the cylindrical wall of the container.

For example the camera may be mounted such that the thermal image contains a portion of the top, or a portion of the bottom of the container, for practical reasons (e.g. space limitations in the apparatus), despite that the data related to the top and the bottom will typically be discarded. Such mounting can for example be used in arrangements where heat is supplied to the container by means of one or more IR radiators (not shown in FIG. 5), for example in order to avoid that the heater is located in the field of view 52 of the camera, or to avoid unwanted reflections, or for any other reason.

The camera 51 can be mounted fixedly or can be mounted movably. In the latter case the apparatus or system further comprises means (not shown) for moving the camera 51, which may be adapted for moving the camera up/down in a direction substantially parallel with the longitudinal axis of the container 50, or in a plane substantially perpendicular to the axis of rotation, or may be adapted to rotate the camera around an axis parallel to the longitudinal axis of the container, or any combination of these. Such mounting means are known in the art, and hence need not be described in detail.

Moving the camera can be used for monitoring a plurality of at least two or at least three containers, or even more, by means of a single camera. If possible, the camera can also be mounted at a sufficiently large distance for allowing capturing of thermal IR images of at least two containers or at least three containers simultaneously. Such mounting can for example be used in chambers having limited space for mounting the camera 51.

It is an advantage of using a thermal IR camera because it allows to determine a temperature without physically contacting the product, and allows to capture a large number of temperatures at once (in a single image, depending on the resolution of the camera), and because the measurement is almost instantaneous, and because it reduces the risk of contamination, in contrast to for example the use of probes inserted in the product.

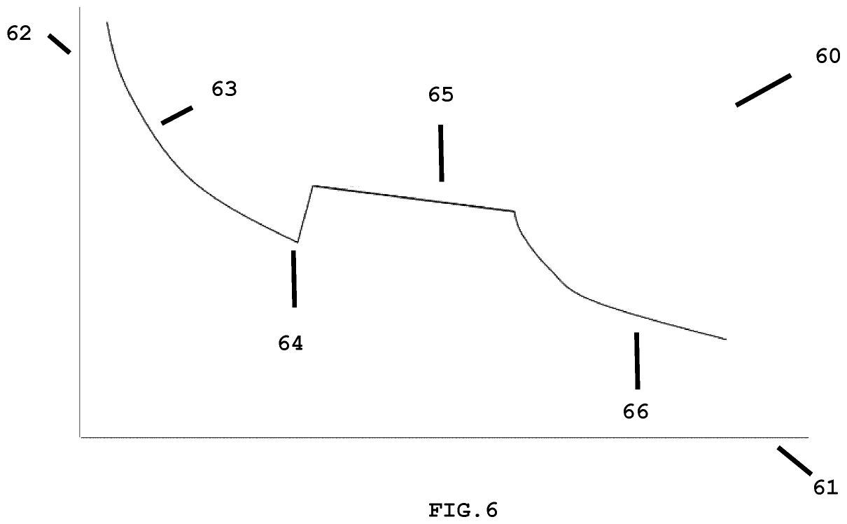

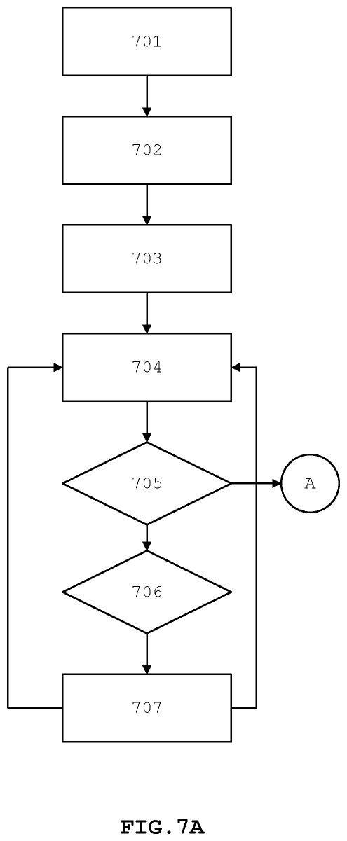

FIG. 6 shows a possible contactless measurement 60, for example using the thermal IR camera, of an exemplary freezing-cycle. The horizontal axis 61 depicts time, while the vertical axis 62 depicts temperature.

In a first step, (sub-)cooling 63 is performed until the onset of crystallization (nucleation) 64. The crystallization phase 65 of the water shows in this example a slowly declining temperature over time. This is because the figure is meant to exemplify a measurement of the wall of the container containing the product that is to be freeze-dried. As the ice layer becomes thicker the temperature of the whole container will still drop, as more coldness becomes available for the already formed ice, even though crystallization is an exothermic process. Further cooling 66 is performed after the crystallization phase has ended.

Annealing or a second crystallization phase is not shown in the example, although the invention is not explicitly limited to the described freezing cycle. A control scheme to effectively control all parameters in the above described freezing cycle will now be described.

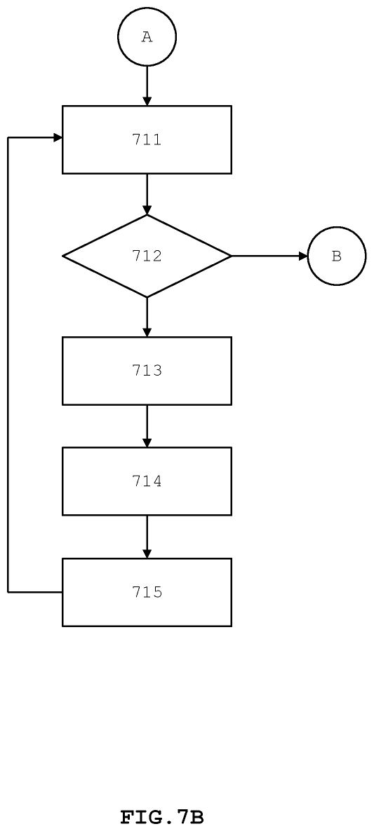

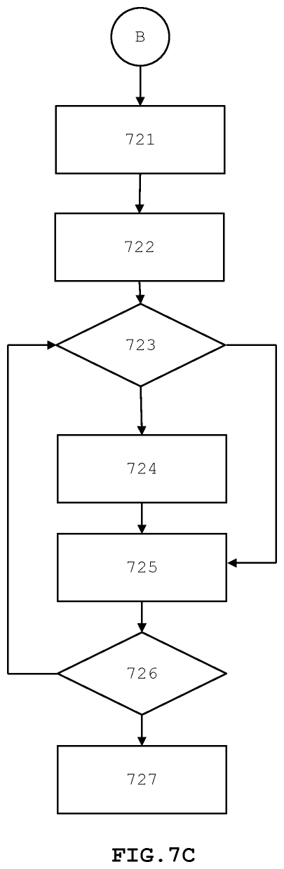

FIG. 7A-7C show a control scheme to be used by a control system to adaptively control the temperature and gas flow rate of the cold gas during (sub-)cooling, nucleation and/or crystallization.

FIG. 7A shows a first part of the control scheme. In step 701, spin-freezing is initiated. One or more vials containing the product to be freeze-dried are entered into the freeze-dryer, more specifically into the compartment of the system where the subcooling takes place. Next, the vials are rotated using an appropriate mechanism known to the skilled person. For example, the vials are vacuum sucked to a holder, and then rotated. Initially, the cylindrical vial rotates at speeds between 2000 and 4000 rpm. The vial can have another shape than purely cylindrical. For example, different sections of the vial taken along the rotation axis, perpendicular to the rotation axis can be rotationally symmetric.

In a preferred embodiment the vial comprising the composition is uniformly cooled. This can be accomplished in a multitude of ways. For example, the vial can rotate and a cooling gas is applied to the rotating vial or the cooling gas supply system can rotate while the vial remains stationary. Another example can be a cooling gas supply system shaped such as to uniformly cool the vial, for example by a multitude of gas jets (at least partly) surrounding the vial, or a ring-shaped gas jet. Another method can be to uniformly cool the vial over time, i.e. while at a particular moment in time the vial may not be cooled uniformly, taken over a period of time the vial is cooled uniformly. For example, a multitude of gas jets can be positioned along a production line, and the vial is cooled by subsequently applying a cooling gas from each gas jet positioned at different locations with respect to the vial.

The vial comprising the composition does not have to be uniformly cooled, but can also be cooled in a non-uniform way.

Preferably, the composition is rotated such that a relatively thin dispersion layer forms along the walls of the vial, which can subsequently be frozen. However, the forming of a relatively thin dispersion layer along the walls of the vial is not a necessity. The dispersion can be frozen in any form inside the vial using the cooling gas.

In step 702, the gas flow rate is set at a particular value. This value can be a pre-determined value, such as after a calibration freezing cycle has been performed on a similar type of product. An exemplary gas flow rate is 11/min-5001/min, more preferably, adjusted to the size of the container and the amount of substance contained.

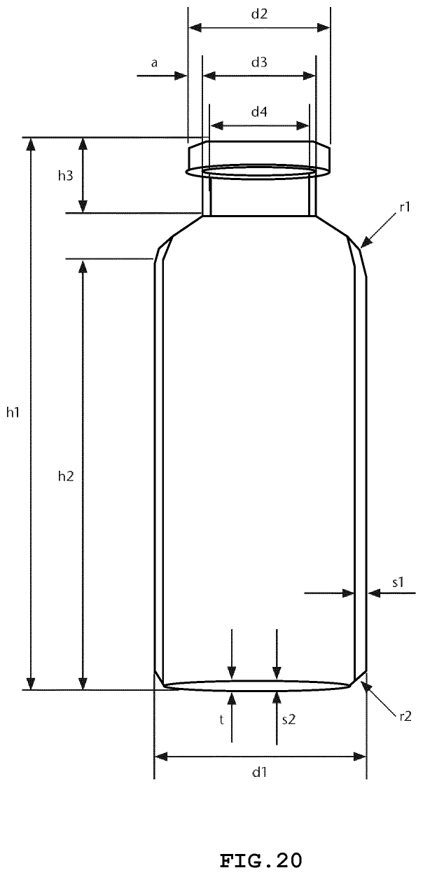

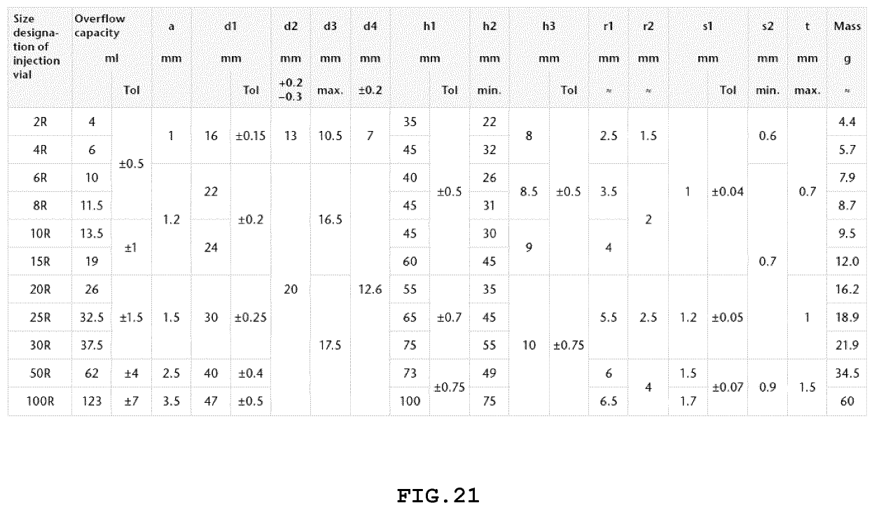

FIG. 20 shows an exemplary vial that can be used in the present invention. FIG. 21 shows a corresponding table to the vial shown in FIG. 20, comprising dimensions for a vial with a particular R-value (Rohr-value).

For a 2R (Rohr) vial, an exemplary flowrate range could be about 1-100 l/min. For a vial, an exemplary flowrate range could be about 5-2501/min. For a 30R vial, the flowrate range could be about 10-5001/min. Preferably, vials with an R value of 10-15R are used.

In a preferred embodiment, the containers used in the present invention are vials used in pharmaceutical processes, for example commonly used in freeze-drying processes. In a preferred embodiment, the vials a volume of 2-40 ml, preferably a volume less than 30 ml, more preferably less than 20 ml, more preferably less than 10 ml, more preferably less than 5 ml, more preferably less than 3 ml.

The method is also applicable to other applications, for example products with applications beneficial to humans and animals, for example blood plasma. The size and shape of containers used in these applications can vary, with a volume of the containers for example up to 1 litre, more preferably 3 litre, more preferably 5 litre, more preferably 10 litre.

The flowrate ranges are associated with the desire to limit the cooling rate in specific situations but are also associated with the heat capacity of the vial and its contents. The same holds for the settings of the crystallization trajectory. In that phase, if one controls the cooling such that a gradual crystallization takes place (usually over a longer period of time), a different crystal size and arrangement is reached. Because all gas parameters can essentially be controlled, the possibility occurs to for example cool rapidly, then slow down the cooling during the crystallization phase, and then cool rapidly again after crystallization has finished until the final temperature is reached.

Generally, the higher the flow rate, the better the gas extracts heat from the composition, since more gas molecules meet the one or more vials.

In step 703, the gas temperature is set at a particular value. This value can also be pre-determined such as determined after a calibration freezing cycle has been performed on a similar type of product. The colder the gas, which is used, the more heat is extracted from the composition for the same flow rate.

Cold gas is thus jetted onto the rotating vial. The resulting heat transfer cools the vial and subsequently the product inside.

By controlling both the flow rate and the temperature of the gas, better control is obtained since the power, i.e. the amount of energy transferred or converted from the composition per unit time, of the gas exerted on the composition can be controlled. This is different from simply controlling temperature of the cooling gas. Temperature of the cooling gas will in general be less responsive to control changes, and thus harder to control. Furthermore, it is harder to model the effect of the temperature of the gas on the change in heat of the composition, since this directly depends on the amount of energy extracted by the cooling gas from the composition and/or the vial. For example, if the flow rate of the cooling gas is low the temperature of the cooling gas will have less of an effect on the cooling of the composition to be freeze-dried than when the flow rate is high.

In this way, the rate of cooling of the liquid can be varied and is thus a parameter for inducing nucleation. This is because the rate of cooling influences the supercooling temperature, and one cools the product until the product temperature is below the crystallization point.

In step 704, the vial is measured. The wall of the vial can be measured using an infrared thermometer and this is included in a controlled feedback loop. In this way, the state of the composition, and the progress of the cooling phase can be measured.

In step 705, it is checked whether the composition is still in liquid phase during cooling. If this is the case, one continues with step 706. Otherwise, one progresses to control point A.

The onset of ice formation (nucleation) is characterized by a relatively steep increase of the temperature. This is detected by continuous measurement of the temperature of the vial during the process. In an alternative embodiment this could also be directly determined using spectroscopic techniques, such as NIR, Raman or Terahertz. Spectroscopic techniques are advantageous in case also the structural information of the crystals is required.

If the composition is still in the liquid phase during cooling, the control system checks in step 706 whether the temperature of the composition is in accordance with the cooling cycle. This can be a pre-determined value and can depend for example on the time the composition has spent being cooled. However, the value does not have to be pre-determined, as it can be determined based on the responsiveness of the composition to the cooling. If the temperature is deemed to be according to the cycle, the control system goes back to step 704. If the temperature is not in accordance with the cooling cycle, the control system moves to step 707.

In step 707, the temperature and/or flowrate of the gas is adjusted. For example, if the temperature of the composition in step 706 is not according to the cycle and deemed too high, the cooling gas temperature is decreased and/or the flow rate increased. If, on the other hand, the temperature of the composition in step 706 is deemed too low, the cooling gas temperature is increased and/or the flow rate decreased. The increase or decrease in temperature of the cooling gas can occur in constant incremental steps, or the rate of change can be varied. For example, if the temperature of the composition is deemed much too high, or much too low according to the freezing cycle, the temperature is decreased or increased more substantially. The flowrate can also control the amount of heat exchanged between the gas and the vial.

Steps 704 until 707 are repeated until the control system reaches control point A. At control point A, the composition is deemed to not be in the liquid cooling phase, i.e. nucleation has occurred, this means the onset of crystallization of the composition.

This onset may be influenced actively by inducing condensation nuclei or by inducing artificial density gradients in the liquid by acoustic waves or pressure waves. This can be done in numerous ways, for example it is possible to induce high-frequency rotation variations, which lead to pressure waves in the fluid which will induce nucleation promoters. For example, the rotational speed can be slowed down and/or sped up such as to induce pressure waves in the fluid. Besides mechanical inducers, thermal shocks may be induced by rapid variations of the cold gas jets, for example variations in the temperature or flow rate of the cooling gas.

In this way, the temperature at which nucleation may start can be influenced and thus be controlled, which also leads to control of the detailed ice structure that starts to crystallize after nucleation occurs.

Thus, in a preferred embodiment of the invention, the process comprising the step of influencing nucleation by inducing artificial density gradients in the liquid.

With reference to FIG. 7B, after the onset of crystallization, in step 711 the vial is measured, for example in the same way as in step 704. Thus, information can be obtained on the temperature of the vial and the composition, and the state of the composition in the crystallization phase.

In step 712, the control system checks if the composition is in the crystallization phase, or not. This check can be done at least partly based on the measurements in step 711. If the composition is no longer in the crystallization phase, then the control system continues to control point B.

If the crystallization phase is deemed to still be ongoing in step 712, then the control system continues to step 713.

In step 713, the cooling gas flowrate is set. This can be done in a similar fashion as for step 702. The gas flow rate is set at a particular value which can be a pre-determined value for the crystallization phase, such as after a calibration freezing cycle has been performed on a similar type of product. An exemplary gas flow rate is 1 l/min-500 l/min, more preferably, adjusted to the size of the container and the amount of substance contained for example as described above.

In step 714, the cooling gas temperature and/or flow rate is set. This can be done in a similar fashion as for step 703. This value can also be pre-determined for the crystallization phase, such as determined after a calibration freezing cycle has been performed on a similar type of product.

In step 715, the control system waits a pre-determined time, such that the cooling gas can act on the composition, and crystallization can continue. After the pre-determined time has expired, the control step continues to step 711 and measures the vial again. Steps 711-715 are repeated until control point B is reached.

Since crystallization is an exothermic process, the removal of heat needs can be controlled to reduce vial-to-vial variation. Moreover, the speed of the crystallization process can be controlled to reduce the stress on labile components in this phase. Thus, the energy transfer from the vial to the stream of cold gas can be controlled in this phase to overcome these problems. This can be done by controlling the temperature of the cooling gas and/or the flow rate of the cooling gas. The flowrate controls the efficiency of the heat transfer to the cooling gas. Together with the process parameters cooling gas temperature and (process) time, the energy dissipation due to crystallization can be controlled in this manner. Thus, the rate of heat removal during crystallization can be varied. Initially this can be just ice, but later during the crystallization phase also the crystallization of excipients in the composition.

At control point B, the crystallization phase is deemed to be finished. The control system then moves to step 721.

With reference to FIG. 7C, from step 721 onwards, the solid composition is further cooled. In this phase the final shape and size of the ice crystals is determined by a process called Ostwald ripening. In this already solid phase, other excipients in the formulation may induce crystallization, which may lead to another cycle of crystallization control. This can again be related to the temperature control of the cold gas or the flow rate control of the cold gas, including the vial temperature in the control loop.

Note that in the current embodiment, only a single crystallization phase occurs. Depending on the composition, multiple crystallization phases can occur. If more than one crystallization phase occurs, the control system can continue to control point A again, and steps 711-715 are repeated until control point B is reached again. The gas flowrate and/or gas temperature, as well as the process defined time can be different for different crystallization phases.

In step 721, the gas flow rate is adjusted. The gas flowrate can be set at a particular value which can be a pre-determined value for the further cooling phase and can be based on a calibration freezing cycle has been performed on a similar type of product. An exemplary gas flow rate is 1 l/min-500 l/min, more preferably, adjusted to the size of the container and the amount of substance contained, as—for example—described above.

In step 722, the vial is measured, for example in the same way as in step 704 and/or step 711. Thus, information can be obtained on the temperature of the vial and the composition, and the state of the composition in the crystallization phase.

Next, in step 723, the control system checks whether the temperature is according to the further cooling cycle. This can be done in the same way as for step 706. The temperature value that the composition and/or vial should have can be a pre-determined value and can depend for example on the time the composition has spent being cooled. However, the value does not have to be pre-determined, as it can be determined based on the responsiveness of the composition to the further cooling. If the temperature is according to the cycle, the control system continues to step 725.

If the temperature is not according to the cycle, the control system continues to step 724 first. In step 724, the cooling gas temperature and/or flowrate is adjusted. This can be done in same way as for step 707. For example, if the temperature of the composition in step 723 is not according to the cycle and deemed too high, the cooling gas temperature is decreased. If, on the other hand, the temperature of the composition in step 723 is deemed too low, the cooling gas temperature is increased. The increase or decrease in temperature of the cooling gas can occur in constant incremental steps, or the rate of change can be varied. For example, if the temperature of the composition is deemed much too high, or much too low according to the freezing cycle, the temperature is decreased or increased more substantially. In an analogous way, the flow rate can be adjusted: increase of the flow rate of the cooling gas increases the speed of cooling, while decreasing the flow rate decreases the cooling. Next, the control system continues to step 725.

In step 725, the control system measures the vial, for example in the same way as in step 722, step 704 and/or step 711. Thus, information can be obtained on the temperature of the vial and the composition, and the state of the composition in the crystallization phase.

In step 726, the control system checks whether the final temperature after further cooling is reached. This is the final temperature of the entire freezing cycle. If the final temperature is not reached, the control system continues to step 723 and repeats 723-726 until the final temperature is reached.

If the final temperature is reached, in step 727 the composition is deemed to be ready and the freezing cycle is completed. By performing steps 721-727, the formation of the final ice structure can be varied. For example, the specific surface area of the ice structure, the shape of the ice crystals, and/or the way the ice crystals are cross-linked can be varied by performing steps 721-727.

The control scheme shown in FIGS. 7A-7C can be performed by a control system in its entirety or can be performed only partly. FIG. 7A describes the initial cooling phase until nucleation occurs. FIG. 7B describes the control during the one or more crystallization phases. FIG. 7C describes the further cooling phase. The more parts of the control scheme are performed, the more control is obtained over the freezing process. By performing the control scheme at least partly, one or more of the following benefits occur: (I) the rate of cooling of the liquid can be varied and used as one parameter for induced nucleation; (II) the temperature at which nucleation may start can be varied, which can also lead to control of the detailed ice structure; (III) the rate of heat removal during crystallization can be varied (initially just ice, but later also for the crystallization of excipients); and (IV) the formation of the final ice structure can be varied.

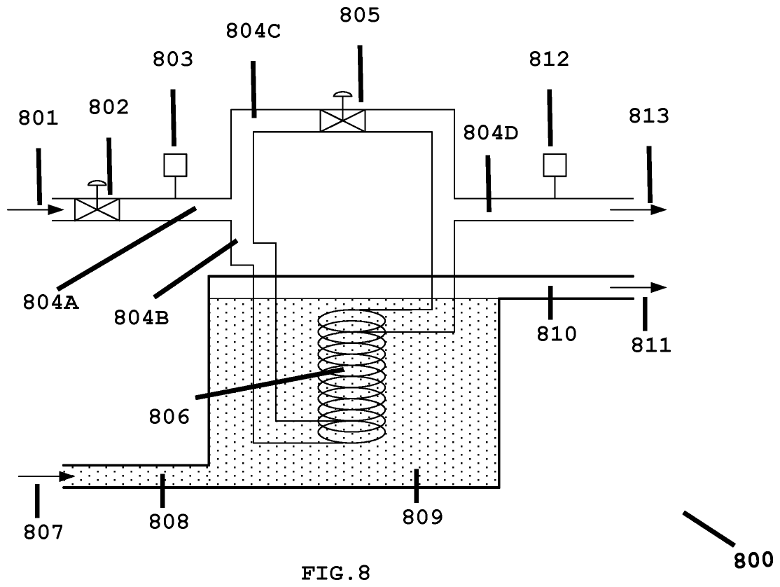

FIGS. 8-10 schematically show three alternatives for a gas cooling system. The gas cooling system generally has as input gas that is to be cooled down, and as output cooling gas that can be used to cool the compositions in a freeze-drying system. Furthermore, the gas cooling systems can be used with the control system and control scheme for freezing in a freeze-drying system described in the present description. However, the gas cooling systems can be used with any freeze-drying system that uses a cooling gas to cool the compositions to be freeze-dried.

FIG. 8 schematically shows a first alternative for a gas cooling system 800.

A gas 801, to be used as a cooling gas, is inserted into gas inflow piping 804A. The gas 801 is preferably an inert gas, for example nitrogen. The gas should be completely free of (dust) particles (viable and non-viable) to prevent contamination of the content of the vials. The inflow rate of the gas 801 can be controlled by valve 802. This can be for example a gate valve with pneumatic membrane actuator, but any valve known to the skilled person can be used. A temperature sensor 803 is used to determine the temperature of the incoming gas 801. Any suitable temperature sensor 803 can be used by the skilled person, for example a Ptl00 temperature sensor or a resistance temperature detector. The gas 801 in general is not cold enough to be used in a freeze-drying process and needs to be cooled before usage.

The inflow piping 804A splits into a primary piping 804B and a secondary piping 804C. The gas that flows through the primary piping 804B flows through a heat exchanger 806. This heat exchanger is immersed in a liquid nitrogen bath 809.

The liquid nitrogen bath 809 has an inflow piping 808 with liquid nitrogen 807 flowing into the bath. The liquid nitrogen extracts heat from the gas 801 via the heat exchanger 806. The liquid nitrogen evaporates because of the extracted heat and is extracted as evaporated nitrogen 811 from outflow piping 810.

The heat exchanger 806 can be for example a winding structure, a helical structure, or any other structure that allows for heat to be exchanged between the liquid nitrogen and the gas 801. An important consideration is that the contact surface between the primary piping 804B and the liquid nitrogen bath 809 is as large as possible, such as to maximize the amount of heat that is exchanged in the heat exchanger 806.

After the heat exchanger 806, the primary piping 804B is joined with the secondary piping 804C. The secondary piping does not have to go through the heat exchanger 806, indeed does not have to undergo any substantial cooling.

The flow rate of the gas 801 that flows through the secondary piping 804C can be controlled via valve 805, which can be the same kind of valve or a different valve from valve 802.

The primary piping 804B and secondary piping 804C meet in the outflow piping 804D for the gas 801. A temperature sensor 812, similar or different from temperature sensor 803, measures the gas flowing through outflow piping 804D. If the temperature of the cooling gas 813 exiting the outflow piping 804D is too high, the valve 805 of the secondary piping 804C is closed (further), so as to force more gas 801 percentwise through the heat exchanger 806 and thus obtain colder cooling gas 813. In a similar manner, if the temperature of the cooling gas 813 exiting the outflow piping 804D is too low, the valve 805 of the secondary piping 804C is opened (further), so as to force less gas 801 percentwise through the heat exchanger 806 and thus obtain warmer cooling gas 813.

As mentioned, the valve 802 controls the flowrate of the gas 801 flowing into the gas cooling system. Therefore, the valve 802 also controls the flowrate of the cooling gas 813 flowing out of the cooling gas.

The gas cooling system 800 thus enables an operator and/or control system to control both the flow rate and temperature of the cooling gas, on a continuous basis if needed.

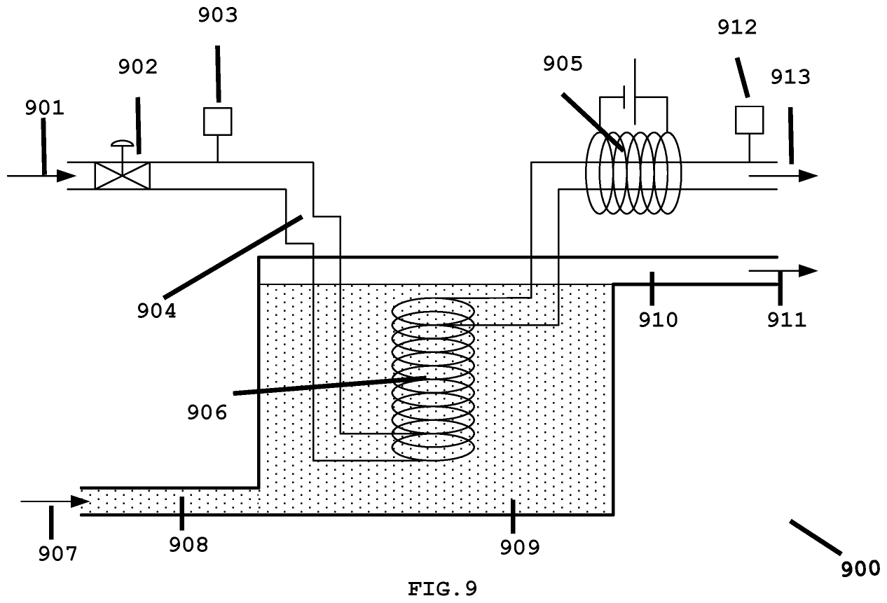

FIG. 9 schematically shows a second alternative for a gas cooling system 900. The second gas cooling system 900 works according to the same principles as the first gas cooling system 800, with some exceptions which will be detailed further below.

A gas 901, to be used as a cooling gas, is inserted into gas inflow piping 904. The inflow rate of the gas 901 can be controlled by valve 902. A temperature sensor 903 is used to determine the temperature of the incoming gas 901. The gas 901 in general is not cold enough to be used in a freeze-drying process and needs to be cooled before usage.

The gas that flows through the piping 904 flows through a heat exchanger 906. This heat exchanger is immersed in a liquid nitrogen bath 909.

The liquid nitrogen bath 909 has an inflow piping 908 with liquid nitrogen 907 flowing into the bath. The liquid nitrogen extracts heat from the gas 901 via the heat exchanger 906. The liquid nitrogen evaporates because of the extracted heat and is extracted as evaporated nitrogen 911 from outflow piping 910.

Next, the gas flows through a heating element 905, which may or may not heat up the gas coming out of the heat exchanger 906. A temperature sensor 912, similar or different from temperature sensor 903, measures the gas flowing through piping after the heating element 905. If the temperature of the cooling gas 913 exiting the piping 804 is too high, the heating element 905 heats the gas less. In a similar manner, if the temperature of the cooling gas 913 exiting the piping 904 is too low, the heating element 905 heat the gas more. In this way the temperature of the cooling gas 913 flowing out of the gas cooling system 900 can be controlled.

As mentioned, the valve 902 controls the flowrate of the gas 901 flowing into the gas cooling system 900. Therefore, the valve 902 also controls the flowrate of the cooling gas 913 flowing out of the cooling gas.

The gas cooling system 900 thus also enables an operator and/or control system to control both the flow rate and temperature of the gas cooling system 900.

Other cryogenic coolants may be considered to replace the bath with liquid nitrogen. An example of such alternative is the application of dry ice (solid carbon dioxide) floating in ethanol to reach minus 79 degrees Celsius. The use of such higher cryogenic temperature may be advantageous in case small cooling rates or slow crystallization processes would need to be obtained.

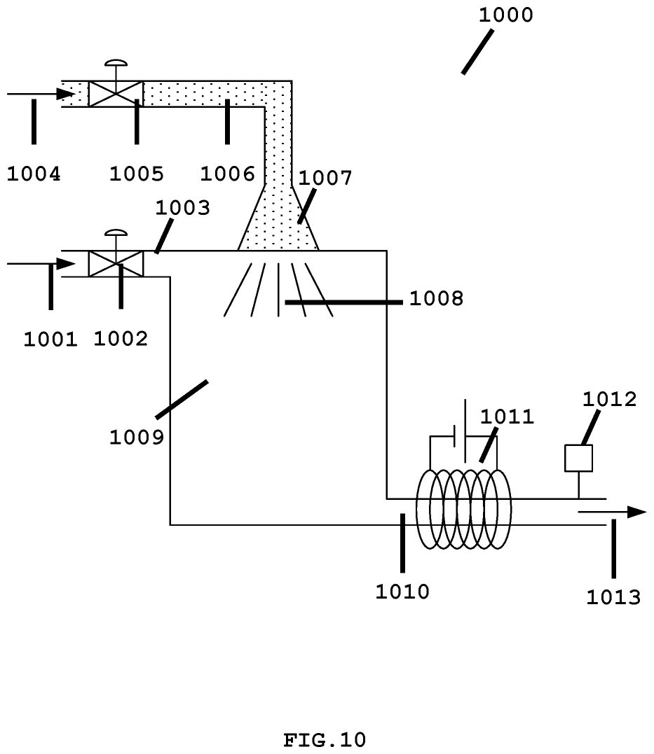

FIG. 10 schematically shows a third alternative for a gas cooling system 1000.

A gas 1001 to be used as a cooling gas in a freeze-drying process enters the gas cooling system 1000 through gas inflow piping 1003. The inflow rate of the gas 1001 can be controlled by valve 1002. Again, the gas 1001 in general is not cold enough to be used in a freeze-drying process and needs to be cooled before usage.

The gas 1001 enters a cooling chamber 1009. The gas 1001 is cooled in the cooling chamber 1009 by ejecting liquid nitrogen 1004 into the cooling chamber 1009 via inflow piping 1006 and an ejector 1007. The liquid nitrogen 1004 flowrate can be controlled via valve 1005.

The ejector 1007 can entrain the liquid nitrogen 1004 in a high-velocity jet. In this way, tiny droplets of liquid nitrogen 1004 enter the cooling chamber 1009 and exchange heat with the gas 1001 to be cooled, i.e. the gas 1001 heats up the liquid nitrogen 1004 and the gas 1001 cools down as a result. The liquid nitrogen 1004 turns into nitrogen gas as a result.

Because the injector 1007 can turn the liquid nitrogen 1004 into tiny droplets, the contact surface is increased, and heat exchange is promoted. This is however not a necessity. The liquid nitrogen 1004 can also just be in direct contact with the cooling gas 1001, and heat exchange can also occur.

The resulting gas exits the cooling chamber via outflow piping 1010. Next, the gas flows through a heating element 1011, which may or may not heat up the gas coming out of the cooling chamber 1009. A temperature sensor 1012, measures the gas 1013 flowing through the outflow piping 1010 after the heating element 1011. In the same way as with the second alternative for a gas cooling system 900 the temperature sensor 1012 measures the outflowing gas 1013 and determines whether the heating element 1011 needs to heat up the gas 1013 or not. In this way the temperature of the cooling gas 1013 flowing out of the gas cooling system 1000 can be controlled.

As mentioned, the valve 1002 controls the flowrate of the gas 1001 flowing into the gas cooling system 1000. Furthermore, the valve 1005 controls the flowrate of the liquid nitrogen 1004 flowing into the gas cooling system 1000. Both valves thus control the flowrate of the cooling gas flowing out of the cooling system 1000.

As a cooling gas, it is best to use an inert gas, such that the gas does not react with the liquid nitrogen injected into the cooling chamber 1009. Preferably, the cooling gas is nitrogen gas.

Any number of gas cooling systems 800, 900 and/or 1000 can be combined to deliver cold cooling gas at a required flow rate to any part of a freeze-drying system. While liquid nitrogen was used as a cooling gas for the gas to be cooled in the above embodiments, this is of course not a necessity, and any other suitable cooling liquid can be used.

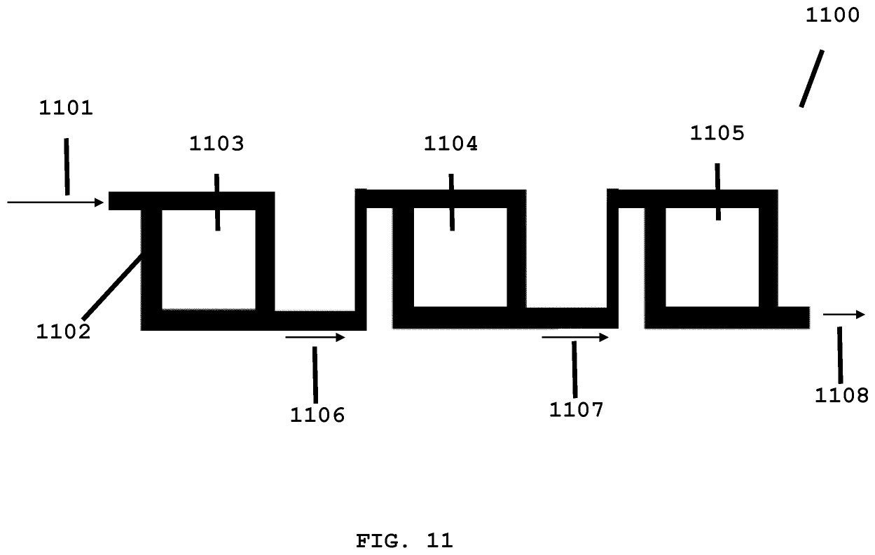

FIG. 11 schematically shows a spin freeze-drying system 1100, where exhaust gas from the freezing step is reused to condition the double-walled chambers.

The spin freeze-drying system 1100 comprises a spin freezing chamber 1103, an annealing chamber 1104 and a sublimation chamber 1105. Exhaust gas 1101 that was used in spin freezing is entered into a double wall structure 1102. The double wall structure 1102 can for example be a piping system wound around the spin freezing chamber 1103. In this way, the walls of the freezing chamber 1103 are cooled using the exhaust gas 1101.

A typical temperature for the exhaust gas from spin freezing is about minus ninety degrees Celsius. By reusing the clean cold gas coming from the spin freezing chamber, this gas is not wasted. This is beneficial, since energy was spent to obtain gas cold enough for spin freezing. Furthermore, by cooling the walls of the spin freezing chamber, less energy is spent cooling the compositions.

A first connection piping 1106 connects the double wall structure 1102 of the spin freezing chamber 1103 with a double wall structure of the annealing chamber 1104. The double wall structure of the annealing chamber 1104 thus uses the remainder of the cold gas used in the double wall structure 1102 of the spin freezing chamber 1103 to cool the walls of the annealing chamber 1104. A typical temperature for the exhaust gas in the first connection piping 1106 is about minus sixty degrees, the exhaust gas having been warmed by cooling the walls of the spinfreezing chamber 1103.

A second connection piping 1107 connects the double wall structure of the annealing chamber 1104 with a double wall structure of the sublimation chamber 1105. The double wall structure of the annealing chamber 1105 thus uses the remainder of the cold gas used in the double wall structure 1102 of the spin freezing chamber 1103 and the double wall structure of the annealing chamber 1104 to cool the walls of the sublimation chamber 1105. A typical temperature for the exhaust gas in the second connection piping 1107 is about minus forty degrees, the exhaust gas having been warmed by cooling the walls of the spinfreezing chamber 1103 and the annealing chamber 1104.

While the spin freeze-drying system 1100 has double wall structures for the spinfreezing chamber, the annealing chamber and the sublimation chamber, any combination of these chambers can have a double wall structure. Furthermore, the double wall structures do not have to be connected in sequence but can be connected in parallel to the exhaust of the spinfreezing chamber. Not only the exhaust gas from the spinfreezing chamber can be used, but any other cooling liquid used in freeze-drying can be used. For example, the evaporated liquid nitrogen 811, 911 used in the first and second alternatives for a gas cooling system 800, 900 can be used to cool the walls of the chambers of the spin freeze-drying system 1100.

By using the excess cold from the cooling liquids from the spin-freezing system, the walls of the different chambers used during freeze-drying can be cooled. In this way, energy is conserved.

Since the chambers can have a double wall structure, also other diathermal gases and fluids may be used to control the temperature of the chamber walls. This may be advantageous in case a rapid cooling of the chamber walls is required after a sterilization process with saturated steam at a temperature above 121 degrees Celsius.

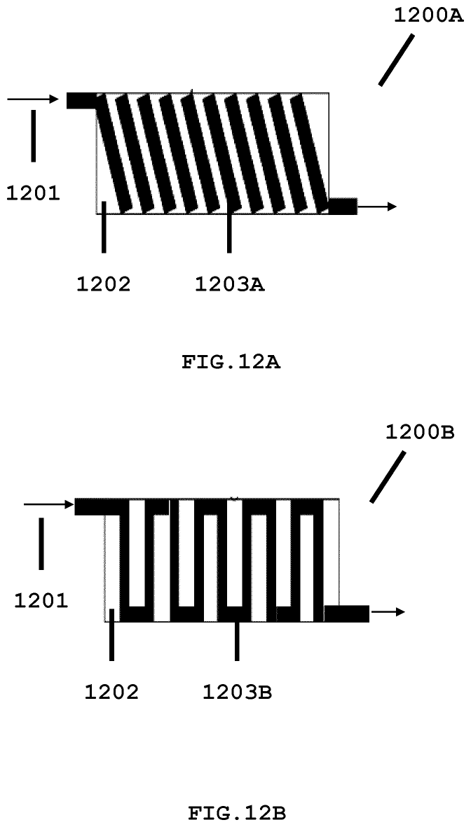

FIGS. 12A and 12B schematically show a cross-section of a double wall structure 1202.

In FIG. 12A, the double wall structure comprises a piping system with helically wound channels 1203A. A cooling liquid 1201 travels through the helically wound channels 1203A. In this way the double wall structure 1202 cools the walls of the chamber that it surrounds. As has been indicated with FIG. 11, this cooling liquid may also be the re-usable exhaust cooling gas.

In FIG. 12B, the double wall structure comprises a piping system with meandering channels 1203A. A cooling liquid 1201 travels through the helically wound channels 1203A.

The helically wound channels and the meandering channels are examples of the layout of the piping in the double wall structure. Other layouts can be used. Preferably, the contact surface with the inner wall of the chamber of the freeze-drying system can be maximized, such that the heat exchange between the cooling liquid 1201 and the inner wall of the chamber is largest. As has been indicated with FIG. 11, this cooling liquid may also be the re-usable exhaust cooling gas.

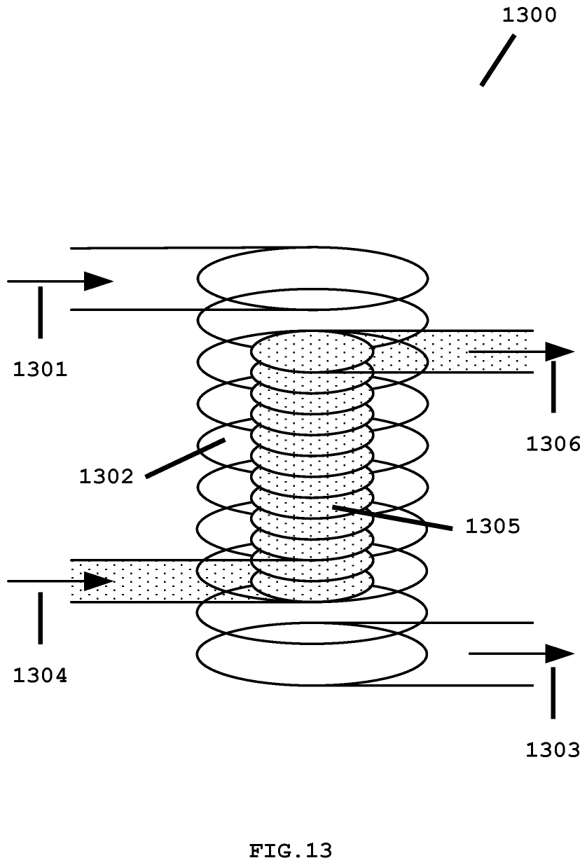

FIG. 13 schematically shows a first heat exchanger 1300 which can be used for pre-cooling gas to be used as cooling gas in a spin freeze-dryer.

A first piping system 1302 and a second piping system 1305 are brought into thermal contact. The first piping system 1302 can be wound around the second piping system 1305. The first piping system 1302 can transport gas 1301 to be pre-cooled by the heat exchanger 1300. The second piping system 1305 can transport gas 1304 coming from an exhaust of the spinfreezing chamber of a spin freeze-dryer system. For example, the gas 1304 was previously used to freeze the compositions to be freeze-dried. The gas 1304 could have been used in other parts of the freeze-dryer system as well. The gas 1301 to be pre-cooled can for example be sterile nitrogen gas.

Because of the thermal contact between the first piping system 1302 and the second piping system 1305, heat is exchanged between the warmer gas 1301 to be pre-cooled and the cooler gas 1304 coming the spin freeze-dryer system. As a result, the warmer gas 1301 is cooled into pre-cooled gas 1303, while the cooler gas 1304 is warmed and exits the heat exchanger 1300 as gas 1306, which can be used further to cool other parts of the spin freeze-dryer system or to pre-cool gas to be used as cooling gas in the spin freeze-dryer.

The pre-cooled gas 1303 can be further cooled by a gas cooling system, such as the first, second and third alternative for a gas cooling system 800, 900, 1000. Other methods of further cooling the gas to a suitable temperature, such that the gas can be used to freeze the compositions to be freeze-dried, can be used.

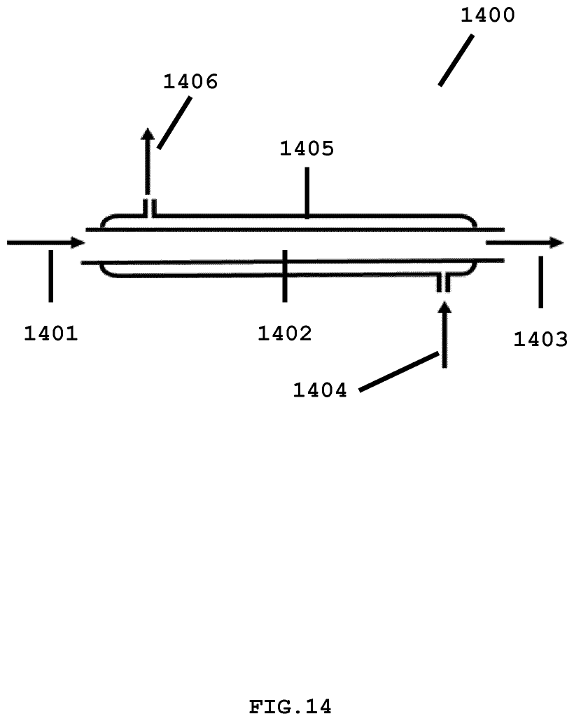

FIG. 14 schematically shows a second heat exchanger 1400 which can be used for pre-cooling gas to be used as cooling gas in a spin freeze-dryer.

The gas to be pre-cooled 1401 is transported along a first piping system 1402. A second piping system 1405 is formed such as to enclose the first piping system 1402 at least partially. Cool gas 1404, for example from a spinfreezing chamber exhaust of a spin freeze-dryer system is transported along the second piping system 1405. Due to the thermal contact between the first piping system 1402 and the second piping system 1405, heat is exchanged between the cool gas 1404 and the gas to be pre-cooled 1401.

Gas 1403 exiting the first piping system 1402 is pre-cooled and can for example be further cooled by a gas cooling system, such as the first, second and third alternative for a gas cooling system 800, 900, 1000. Other methods of further cooling the gas to a suitable temperature, such that the gas can be used to freeze the compositions to be freeze-dried, can be used.

Gas 1406 exiting the second piping system is generally warmer than the cool gas 1404 entering the second piping system. If the gas 1406 exiting the second piping system is still cold enough for other applications within the spin freeze-dryer system, the gas 1406 can be further used to cool components, or cooling liquids.

In another embodiment, compressor driven cooling circuits can be used together with a heat exchanger to cool gas to be used as cooling gas for the compositions to be freeze-dried. In that case, exhaust gas from a particular part of the spin freeze-dryer can be used to provide cooling for the compressor system used in the compressor driven cooling circuit.

Compressors work conform Carnot cycles. A gas is compressed to a liquid state (in this step the temperature of the gas also rises). Next, using a heat exchanger and a cooling liquid, the compressed liquid is cooled. Next, the liquid is allowed to evaporate and expand, wherein heat is extracted from the object that needs to be cooled. The expanded gas is then compressed again in a repeating cycle. The object that needs to be cooled can either be the freezing chamber, sublimation chamber, annealing chamber, cooling fluid. The exhaust gas from the freezing chamber can thus be used to cool down the compressed liquid in this cycle.

Note that the application of induced nucleation by external means such as gases generally introduces additional challenges in terms of Good Manufacturing Practice (GMP) requirements. For example, all ducts and piping used can be included into the system's sterilization process. Using mechanical means to induce local density variations may lead to an increase generation of particles. Therefore, it can be important to assure a (strictly) directional flow of cooling gas, such that these particles are conveyed to the exhaust without getting in the neighbourhood of the opening of the vials. In this way, contamination can be avoided.

The vial with frozen material can be used in a next step in a freeze-drying process. This freeze-drying process can be a conventional process, just applying vacuum while increasing the temperature of a vacuum chamber. In case the vial with frozen material is used in a freeze-drying process, such freeze drying process preferably is a controlled freeze drying process as described in WO2018/033468 A1.

In another application, the vial with frozen material can be used as such, till the material is thawed. The vial with frozen material can be stored for one day or more, one week or more, or longer, like one or several months. The frozen material can in the meantime be transported to other places while being kept in a frozen state, like for example by cooling with liquid nitrogen or solid carbon dioxide.

While freeze drying often is performed on proteins, freeze drying and/or freeze-thawing is preferably done on mixtures of live cells in a water based medium.

Thawing is performed on frozen compositions, usually containing crystallized excipients and ice. For example, the frozen composition to be thawed can be the result of a freezing cycle as explained above.

The thawing cycle can be performed in a thawing chamber. The setup of the thawing chamber can be similar to the setup schematically shown in FIG. 3A or FIG. 3B. However, instead of using a cooling gas, generally a gas relatively warmer than the composition and/or the vial containing the frozen composition is used to heat up the composition. In this way, when the heating gas reaches the vial comprising the frozen composition, heat is extracted from the heating gas and supplied to the vial and subsequently the composition. The gas can be an inert gas such as nitrogen, but other inert gases such as Argon or Helium may be applied. Also, carbon dioxide gas may be applied, depending of the composition of the contents in the vial.

By rotating the vial comprising the composition, heat is applied to the composition in a uniform way. Therefore, in a preferred embodiment, the composition may be rotated and heated by a flow of heating gas.

As mentioned above, in a preferred embodiment the vial comprising the composition is uniformly heated. This can be accomplished in a multitude of ways. For example, the vial can rotate, and a heating gas is applied to the rotating vial or the heating gas supply system can rotate while the vial remains stationary. Another example can be a heating gas supply system shaped such as to uniformly heat the vial, for example by a multitude of gas jets (at least partly) surrounding the vial, or a ring-shaped gas jet. Another method can be to uniformly heat the vial over time, i.e. while at a particular moment in time the vial may not be heated uniformly, taken over a period of time the vial is heated uniformly. For example, a multitude of gas jets can be positioned along a production line, and the vial is heated by subsequently applying a heating gas from each gas jet positioned at different locations with respect to the vial.

The vial comprising the composition does not have to be uniformly heated, but can also be heated in a non-uniform way.

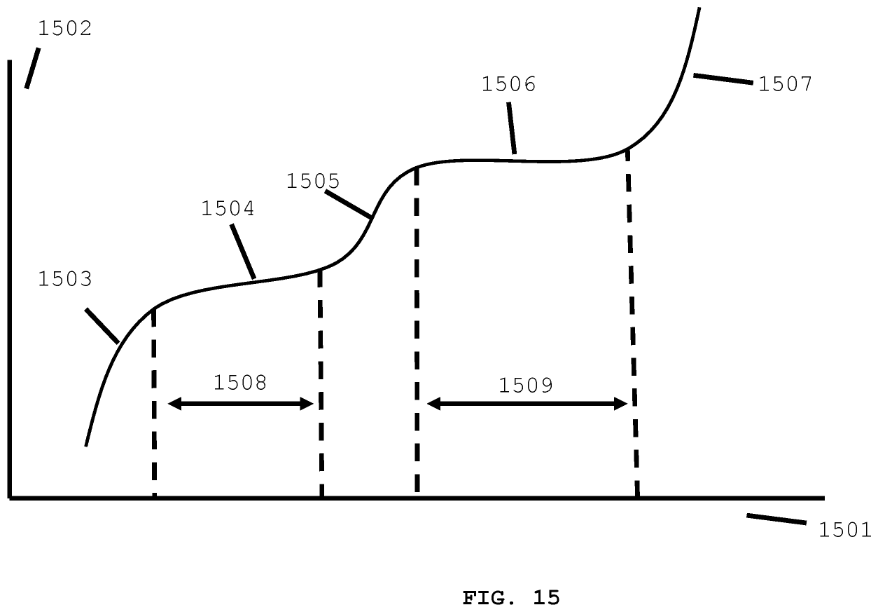

FIG. 15 illustrates an exemplary thawing cycle. The horizontal axis 1501 depicts time, while the vertical axis 1502 depicts temperature.

In a first step, the composition is rapidly heated 1503 to the first eutectic point. At this point, which is the lowest possible melting temperature for the involved component species, one of the excipients will start to de-crystallize.

During a de-crystallization time 1508 of the excipient, the excipient subsequently de-crystallizes 1504. The length of the de-crystallization time 1508 can be controlled as further explained below.

Next, the composition is rapidly heated 1505 such that the temperature of the composition reaches the melting point of ice. During a melting time 1509 the ice in the composition melts 1506. Also, the length of the melting time 1509 can be controlled as further explained below.

When the composition is fully in liquid form, the composition can be further rapidly heated 1507 to reach the final temperature.

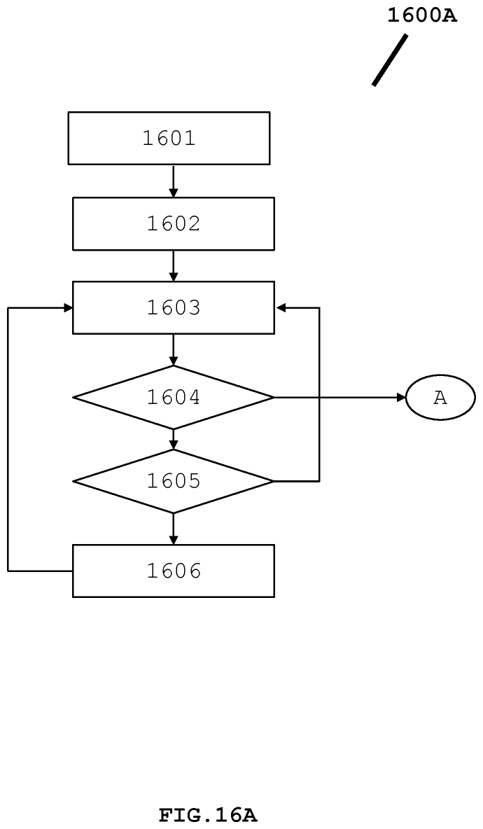

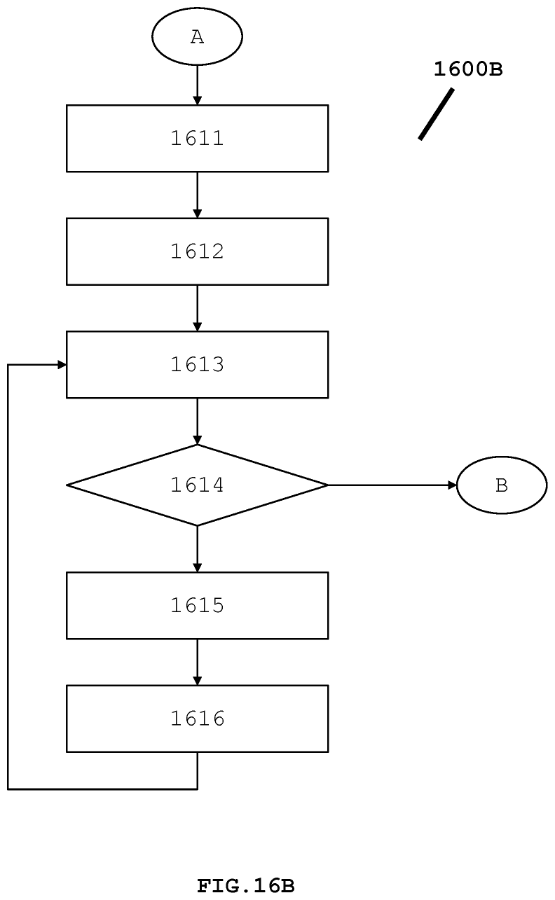

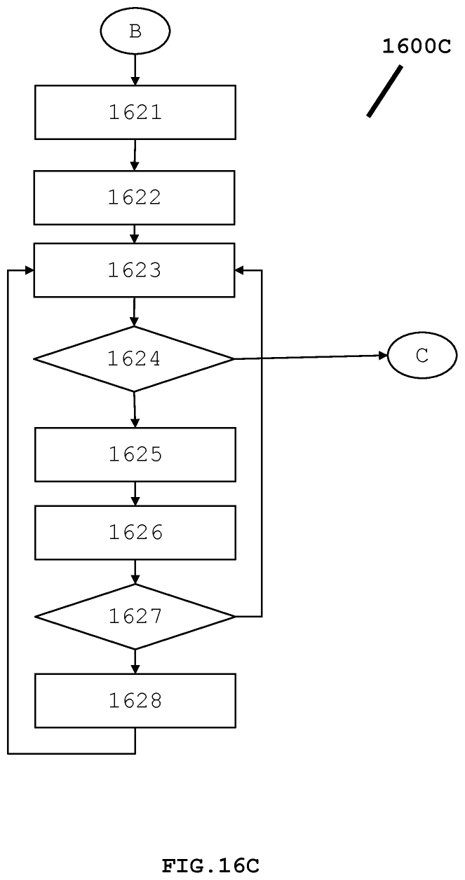

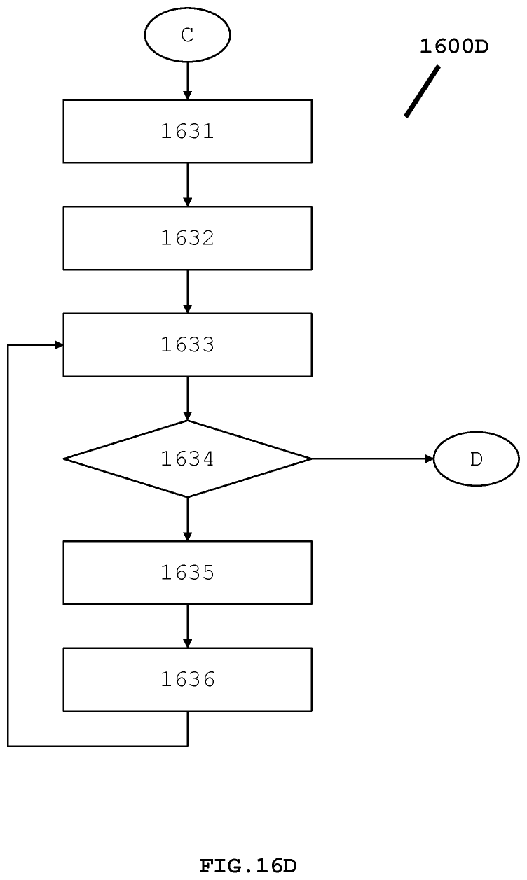

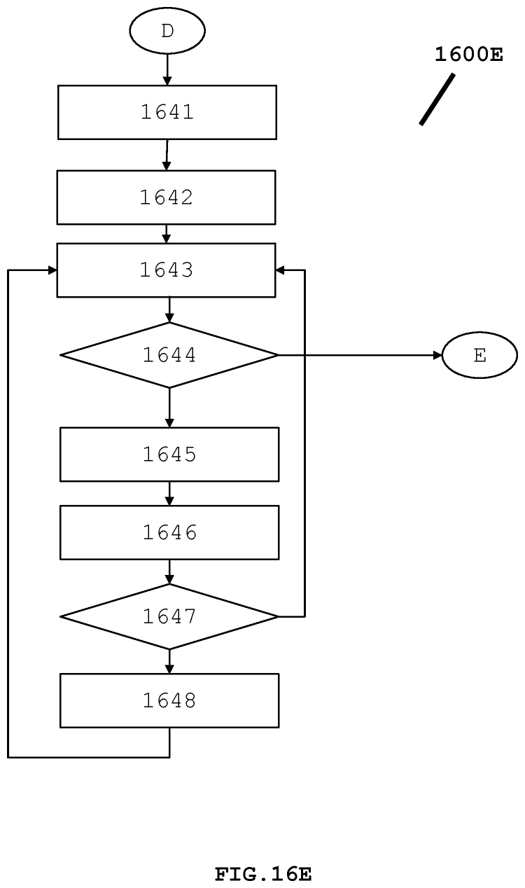

FIGS. 16A-16E show a control scheme 1600A-E to be used by a control system to adaptively control the temperature and gas flow rate of the cold gas during thawing of a frozen product.

FIG. 16A shows a part of the control scheme 1600A, for example applicable during the rapid heating phase 1503 of a thawing cycle.

In step 1601, the flowrate of the gas is set at a particular value. This value can be a pre-determined value, such as after a calibration thawing cycle has been performed on a similar type of product. An exemplary gas flow rate is 1 l/min-500 l/min, more preferably, adjusted to the size of the container and the amount of substance contained. The faster the flow rate, the better the gas heats the composition, since more gas molecules meet the one or more vials.

In step 1602, the gas temperature is set at a particular value. This value can also be pre-determined such as determined after a calibration thawing cycle has been performed on a similar type of product. The warmer the gas which is used, the more heat is added to the composition for the same flow rate.

Relatively warm gas is thus jetted onto a vial comprising the composition. The resulting heat transfer warms the vial and subsequently the product inside. Preferably, the vial rotates, such as to obtain an optimal heat distribution over the vial.

In step 1603, the vial is measured. The wall of the vial can be measured using an infrared thermometer (as described above in FIGS. 4 and 5) and this is included in a controlled feedback loop. In this way, the state of the composition, and the progress of the heating phase can be measured.

In step 1604, it is checked whether the composition reached the eutectic point, at which point one of the excipients will start to de-crystallize. If this is the case, one continues with control point A. Otherwise, one progresses to step 1605.

If the composition has not yet reached the eutectic point during heating, the control system checks in step 1605 whether the temperature of the composition is in accordance with the thawing cycle. This can be a pre-determined value and can depend for example on the time the composition has spent being heated. However, the value does not have to be pre-determined, as it can be determined based on the responsiveness of the composition to the heating. If the temperature is deemed to be according to the cycle, the control system goes back to step 1603. If the temperature is not in accordance with the thawing cycle, the control system moves to step 1606.

In step 1606, the temperature and/or the flowrate of the gas is adjusted. For example, if the temperature of the composition in step 1605 is not according to the cycle and deemed too low, the heating gas temperature is increased. The increase or decrease in temperature of the heating gas can occur in constant incremental steps, or the rate of change can be varied.

Steps 1603 until 1606 are repeated until the control system reaches control point A. At control point A, the composition is deemed to have reached the eutectic point, at which point one of the excipients will start to de-crystallize. A pre-determined amount of time may have passed between steps 1606 and 1603.

FIG. 16B shows a part of the control scheme 1600B, for example applicable during the excipient de-crystallization phase 1504 of a thawing cycle.

In step 1611, the flowrate of the gas is set at a particular value. This value can be a pre-determined value, such as after a calibration thawing cycle has been performed on a similar type of product.

In step 1612, the gas temperature is set at a particular value. This value can also be pre-determined such as determined after a calibration thawing cycle has been performed on a similar type of product.

In step 1613, the vial is measured. The wall of the vial can be measured using an infrared thermometer and this is included in a controlled feedback loop. In this way, the state of the composition, and the progress of the heating phase can be measured.

In step 1614, it is checked whether the composition comprises anymore crystallized excipient. If the composition does not contain any more crystallized excipient, the control scheme continues with control point B. Otherwise, the control scheme progresses to step 1615.

If the composition still contains crystallized excipient, the control system controls in step 1615 the flowrate of the heating gas. This control can be based on a temperature measurement of the composition, to check whether the temperature of the composition is in accordance with the de-crystallization phase or based on a pre-determined control function.

In step 1616, the temperature of the heating gas is controlled. This can be done for example on the basis of a temperature measurement as performed in step 1615, on a separate temperature measurement, or based on a pre-determined control function.

Steps 1613 to 1616 are repeated until control point B is reached, and the excipient has de-crystallized. A pre-determined amount of time may have passed between steps 1616 and 1613.

FIG. 16C shows a part of the control scheme 1600C, for example applicable during the heating phase 1505 before the melting of ice of a thawing cycle.

In step 1621, the flowrate of the gas is set at a particular value. This value can be a pre-determined value, such as after a calibration thawing cycle has been performed on a similar type of product.

In step 1622, the gas temperature is set at a particular value. This value can also be pre-determined such as determined after a calibration thawing cycle has been performed on a similar type of product.

In step 1623, the vial is measured. The wall of the vial can be measured using an infrared thermometer and this is included in a controlled feedback loop. In this way, the state of the composition, and the progress of the heating phase can be measured.

In step 1624, it is checked whether the ice comprised in the composition started melting. If the ice comprised in the composition started melting, the control scheme continues with control point C. Otherwise, the control scheme progresses to step 1625.

If the ice comprised in the composition did not start to melt, the control system controls in step 1625 the flowrate of the heating gas. This control can be based on a temperature measurement of the composition, to check whether the temperature of the composition is in accordance with the heating phase or based on a pre-determined control function.

In step 1626, the temperature of the heating gas is controlled. This can be done for example based on a temperature measurement as performed in step 1625, on a separate temperature measurement, or based on a pre-determined control function.

In step 1627, the temperature of the vial is measured, and it is checked whether the temperature is in accordance with the heating phase. If the temperature is in order, the control scheme continues with step 1623, otherwise the temperature of the gas and/or the flowrate of the gas are adjusted in step 1628. A pre-determined amount of time may have passed between steps 1628 and 1623.

Steps 1623 to 1628 are repeated until control point C is reached, and the ice comprised in the composition has started melting.

FIG. 16D shows a part of the control scheme 1600D, for example applicable during the ice melting phase 1506 of a thawing cycle.

In step 1631, the flowrate of the gas is set at a particular value. This value can be a pre-determined value, such as after a calibration thawing cycle has been performed on a similar type of product.

In step 1632, the gas temperature is set at a particular value. This value can also be pre-determined such as determined after a calibration thawing cycle has been performed on a similar type of product.

In step 1633, the vial is measured. The wall of the vial can be measured using an infrared thermometer and this is included in a controlled feedback loop. In this way, the state of the composition, and the progress of the ice melting phase can be measured.

In step 1634, it is checked whether the composition comprises anymore ice. If the composition does not comprise anymore ice, the control scheme continues with control point D. Otherwise, the control scheme progresses to step 1635.

If the composition still contains crystallized excipient, the control system controls in step 1635 the flowrate of the heating gas. This control can be based on a temperature measurement of the composition, to check whether the temperature of the composition is in accordance with the de-crystallization phase or based on a pre-determined control function.

In step 1636, the temperature of the heating gas is controlled. This can be done for example on the basis of a temperature measurement as performed in step 1635, on a separate temperature measurement, or based on a pre-determined control function.

Steps 1633 to 1636 are repeated until control point D is reached, and the ice comprised in the composition has melted. A pre-determined amount of time may have passed between steps 1636 and 1633.

FIG. 16E shows a part of the control scheme 1600E, for example applicable during the final heating phase 1507 after the ice comprised in the composition has melted during a thawing cycle.

In step 1641, the flowrate of the gas is set at a particular value. This value can be a pre-determined value, such as after a calibration thawing cycle has been performed on a similar type of product.

In step 1642, the gas temperature is set at a particular value. This value can also be pre-determined such as determined after a calibration thawing cycle has been performed on a similar type of product.

In step 1643, the vial is measured. The wall of the vial can be measured using for example an infrared thermometer and this is included in a controlled feedback loop. In this way, the state of the composition, and the progress of the heating phase can be measured.

In step 1644, it is checked whether the use temperature of the composition is reached. This is the temperature goal of the thawing cycle for this particular composition. If the use temperature reached, the control scheme continues with control point C and the product is ready to use. For example, the product can be extracted from the thawing chamber and further processed. Otherwise, the control scheme progresses to step 1645.

If the use temperature has not yet been reached, the control system controls in step 1645 the flowrate of the heating gas. This control can be based on a temperature measurement of the composition, to check whether the temperature of the composition is in accordance with the heating phase or based on a pre-determined control function.

In step 1646, the temperature of the heating gas is controlled. This can be done for example on the basis of a temperature measurement as performed in step 1645, on a separate temperature measurement, or based on a pre-determined control function.

In step 1647, the temperature of the vial is measured, and it is checked whether the temperature is in accordance with the heating phase. If the temperature is in order, the control scheme continues with step 1643, otherwise the temperature of the gas and the flowrate of the gas are adjusted in step 1648.

Steps 1643 to 1648 are repeated until control point E is reached, and the composition is ready for use. A pre-determined amount of time may have passed between steps 1648 and 1643. The thawing cycle is completed when control point E is reached.

The control schemes 1600A-1600E can be combined to control a full thawing cycle, or can only partly be applied to control parts of the thawing cycle of a particular composition. It can happen that more than one excipient de-crystallizes for a particular composition, in that case control schemes 1600A-1600B can be repeated as many times as necessary.

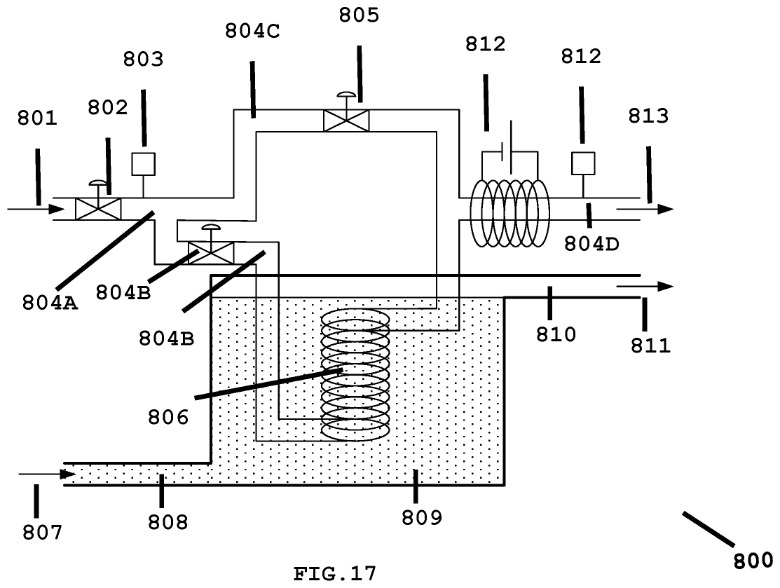

FIG. 17 schematically shows a gas cooling/heating system, which is an adaptation of the gas cooling system shown in FIG. 8. The primary piping 804B can have a separate valve to regulate the flowrate of gas flowing into the heat exchange element 806. For example, the gas flowrate flowing into the heat exchange element 806 can be set to zero. In this way, the gas 801 only flows through secondary piping 804C.

A heating element in the outflow piping 804D can increase the temperature of the gas 813 flowing out of the gas cooling/heating system, in such a way that the temperature of the gas 813 flowing out of the gas cooling/heating system is at a value suitable for use in a thawing cycle. Due to temperature sensor 812, the temperature of the gas 813 to be used as heating gas in the thawing cycle can be controlled.

The heating element can regulate the amount of power exerted on the outflowing gas, such that the amount of heating done by the heating element is controllable.

In the same way, FIG. 10 can be used as a gas heating system by stopping the inflow of the liquid nitrogen at the top by closing valve 1005, and heating the gas flowing into system via piping 1003 by heating element 1011.

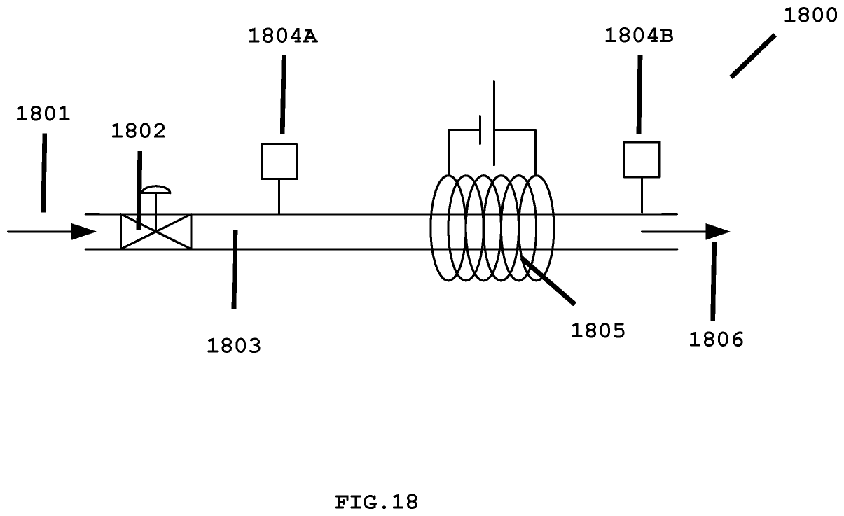

FIG. 18 schematically shows a gas heating system 1800.

Gas to be heated flows into piping 1803. A valve 1802 controls the flowrate of the gas 1801 flowing through piping 1803. A temperature sensor 1804A can measure the temperature of the gas 1801, before the gas is heated by heating element 1805. After the heating element 1805, temperature sensor 1804B can be placed, to measure the temperature of the gas after being heated by the heating element 1805 and to control the heating element 1805. The temperature measurements of the two temperature sensors 1804A,1804B can be compared, to control the heating element 1805 more effectively, One or more heating elements can be placed subsequently along the flow path of the gas. The gas 1806 is heated up to a particular temperature such that the heating gas can be used in the thawing cycle for a particular temperature setting of the gas 1806, and a particular flowrate of the gas 1806.

It is noted that the gas, after being used as heating gas in the thawing chamber, will still contain energy in the form of heat, which can be reused.

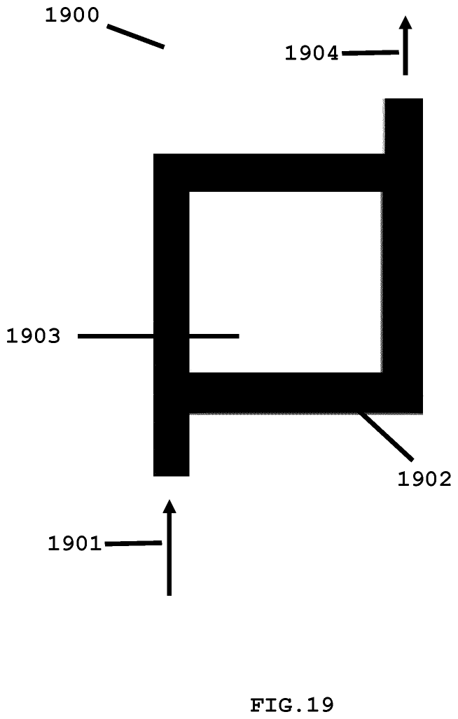

FIG. 19 schematically shows a thawing system, where exhaust gas from the thawing cycle is reused to condition the double-walled chambers of the thawing chamber.

Exhaust gas from the thawing chamber 1901 flows into the double-wall structure 1902, which at least partially surrounds the thawing chamber 1903. In this way, the leftover energy comprised in the heating gas heats up the thawing chamber, so that the thawing chamber can be heated to and maintained at a particular operating temperature. The used exhaust gas 1904 flows out of the double-wall structure.

The double-wall structure can be formed using piping similarly to the cross-section of the double wall structure shown in FIG. 12A-12B.

Furthermore, exhaust gas from the thawing chamber can be reused to pre-heat the gas to be used as heating gas, in an heat exchange structure similar to FIGS. 13 and 14. Using the heat exchange structures in this way, the exhaust gas from the thawing chamber pre-heats the gas still to be used as heating gas.

Note that in principle, the thawing chamber and the freezing chamber can be identical. In other words, a thawing chamber according to the invention can also be used as a freezing chamber according to the invention, and vice versa. In principle, the control scheme and the cooling/heating gas used in the process determines whether freezing or thawing is being performed. In a particular process, a product can be frozen according to the invention and thawed according to the invention in the same chamber.

This highlights a symmetry between the freezing method and the thawing method described herein. By controlling the temperature and the flowrate of the cooling/heating gas and using a control scheme as described herein, in a similar fashion the processes of freezing and thawing are improved.

Two or more of the above embodiments may be combined in any appropriate manner

### Experimental Results

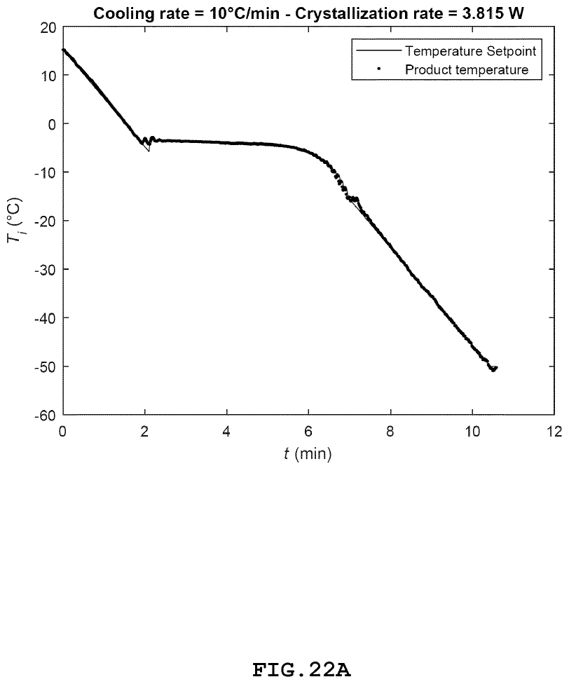

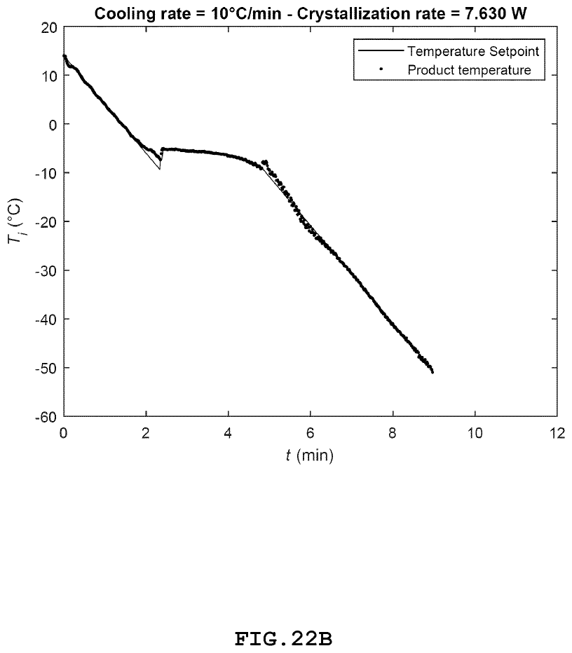

In FIGS. 22A and 22B, two experimental results of the present invention are shown.

Namely, the temperature setpoint and product temperature for a particular vial i are given as Tᵢ in degrees Celsius over time t in minutes. In the experiment, a contactless measurement, using an thermal IR camera, of an exemplary freezing-cycle was performed. Thus, a measurement is done of the wall of the container containing the product that is to be freeze-dried. The product is a water based dispersion of cells with a lyoprotectant in both experiments.

The experiments are similar in the sense that in a first step, (sub-)cooling was performed until the onset of crystallization (nucleation). The crystallization phase of the water shows a slowly declining temperature over time. As the ice layer becomes thicker the temperature of the whole container will still drop, as more coldness becomes available for the already formed ice, even though crystallization is an exothermic process. Further cooling is performed after the crystallization phase has ended.

Both experiments are performed at a cooling rate of 10 degrees Celsius per minute, as can be seen in the (sub-)cooling/initial cooling phase and the further cooling/final cooling phase after the crystallization phase. Indeed, the temperature setpoint curve is followed closely, and the temperature and/or flow rate of the cooling gas is controlled such that the temperature of the vial and/or the dispersion is in accordance with a pre-determined initial- and final cooling temperature evolution over time.

During the crystallization phase, a crystallization rate of respectively 3.815 W and 7.630 W was used. Also in this case, the temperature and/or flowrate of the cooling gas is controlled such that the temperature of the vial and/or the dispersion is in accordance with a pre-determined crystallization temperature evolution over time as indicated by the temperature setpoint.

Because the crystallization rate can be varied, it can be seen that the total crystallization time can be controlled effectively. Namely, the higher the power of the cooling gas, the shorter the crystallization time.

In both experiments, it can be seen that the product temperature closely follows the temperature setpoints. Therefore, using the claimed method, the (parameters of the) freezing cycle can be tightly controlled.

1. Method for changing the phase of a composition, in particular a pharmaceutical composition, comprising:
storing a quantity of the composition in a vial;
changing the phase of the composition in the vial by applying thermal gas to the vial; and
wherein changing the phase of the composition comprises freezing or thawing the composition, and wherein the thermal gas is respectively a cooling gas or a heating gas;
wherein changing the phase of the composition is characterized by performing at least one of (A), (B), (C), wherein (A) is an initial temperature change control scheme performed before entering a phase wherein the crystallization amount of the composition changes; (B) is a crystallization change control scheme during a phase wherein the crystallization amount of the composition changes; (C) is a final temperature change control scheme performed until the composition reaches its final temperature;
obtaining the composition after the change in phase is complete;
wherein the initial temperature change control scheme (A) comprises:
(I) performing an initial measurement on the vial and/or the composition to determine whether the phase wherein the crystallization amount of the composition changes has started;
(II) controlling the temperature and/or flow rate of the thermal gas such that the temperature of the vial and/or the composition is in accordance with a pre-determined initial temperature evolution over time; and
repeating steps (I) and (II) until the initial measurement determines that the phase wherein the crystallization amount of the composition changes has started;
wherein the crystallization change control scheme (B) comprises:
(I) performing a crystallization-change measurement on the vial and/or the composition to determine whether there is no longer a change in the crystallization amount in the composition;
(II) controlling the temperature and/or flowrate of the thermal gas such that the temperature of the vial and/or the composition is in accordance with a pre-determined crystallization-change temperature evolution over time;
repeating steps (I) and (II) until there is no longer a change in the crystallization amount in the composition; and
wherein the final temperature change control scheme (C) comprises:
(I) controlling the temperature and/or flow rate of the thermal gas such that the temperature of the vial and/or the composition is in accordance with a pre-determined final temperature evolution over time;
(II) performing a final temperature measurement on the vial and/or the composition to determine whether the vial and/or the composition has reached its pre-determined final temperature; and
repeating steps (I) and (II) until the final temperature measurement determines that the vial and/or the composition has reached its pre-determined final temperature.

2. The method according to claim 1, wherein in at least one of (A), (B) and (C) before repeating steps (I) and (II), the control scheme can wait a pre-determined amount of time.

3. The method for freezing injectable compositions according to claim 1, wherein the initial measurement, the crystallization-change measurement, and/or the final temperature measurement are performed using a thermal sensor for capturing thermal information and/or a sensor for capturing spectroscopy information.

4. The method according to claim 1, wherein changing the phase of the composition is freezing the composition;
wherein the composition is injectable and stored in the vial as a quantity of a dispersion of the injectable composition in an aqueous dispersion medium;
wherein the initial temperature change control scheme is an initial cooling control scheme (X) before nucleation has occurred in the dispersion layer, wherein the crystallization change control scheme is a crystallization control scheme (Y) during crystallization of the dispersion layer, and wherein the final temperature change control scheme is a final cooling control scheme (Z) after the dispersion layer has crystallized;
wherein in the initial cooling control scheme (X) the initial measurement is a nucleation measurement to determine whether nucleation has occurred in the dispersion, wherein the initial temperature evolution over time is an initial cooling temperature evolution over time, and wherein steps (I) and (II) are repeated until the nucleation measurement determines that nucleation has occurred in the dispersion;
wherein in the crystallization control scheme (Y) the crystallization-change measurement determines whether crystallization has finished in the dispersion, wherein the crystallization-change temperature evolution over time is a crystallization temperature evolution over time, and wherein steps (I) and (II) are repeated until the crystallization measurement determines that crystallization has finished in the dispersion; and
wherein in the final cooling control scheme (Z) the final temperature evolution over time is a final cooling temperature evolution over time.

5. The method for freezing injectable compositions according to claim 4, wherein (X) and (Y), (Y) and (Z), (X) and (Z), or (X), (Y) and (Z) are performed.

6. The method for freezing an injectable composition according to claim 4, wherein the initial cooling control scheme (X) further comprises inducing condensation nuclei in the distribution, and/or inducing artificial density gradients in the composition by acoustic waves or pressure waves, and/or inducing thermal shocks in the distribution.

7. The method for freezing an injectable composition according to claim 4, wherein the method further comprises:
rotating the vial at least for a period of time to form a dispersion layer at an inner surface of a circumferential wall of the vial;
cooling the vial by applying cooling gas to the rotating vial.

8. The method for freezing an injectable composition according to claim 4, wherein the method is a method for freeze-drying injectable compositions, by additionally performing a drying step while applying a vacuum and supplying heat.

9. The method according to claim 1, wherein changing the phase of the composition is thawing the composition;
wherein the composition is frozen;
wherein the initial temperature change control scheme is an initial heating control scheme (V) during a heating phase before a eutectic point is reached in the composition and/or a secondary heating control scheme (X) during a heating phase before a melting point of water in the composition is reached, wherein the crystallization change control scheme is a de-crystallization control scheme (W) during an excipient de-crystallization phase and/or a melting control scheme (Y) during a melting of ice phase, and wherein the final temperature change control scheme is a final heating control scheme (Z) to reach a use temperature of the composition;
wherein in the initial heating control scheme (V) the initial measurement is a eutectic point measurement to determine whether the composition has reached the eutectic point, wherein the initial temperature evolution over time is an initial heating temperature evolution over time, and wherein steps (I) and (II) are repeated until the eutectic point measurement determines that the composition has reached the eutectic point;
wherein in the de-crystallization control scheme (W) the crystallization-change measurement is a de-crystallization measurement to determine whether de-crystallization has finished in the composition, wherein the crystallization-change temperature evolution over time is a de-crystallization temperature evolution over time and wherein steps (I) and (II) are repeated until the de-crystallization measurement determines that de-crystallization has finished in the composition;
wherein in the secondary heating control scheme (X) the initial measurement is a melting point measurement to determine whether the composition has reached the melting point of ice comprised in the composition, wherein the initial temperature evolution over time is a secondary heating temperature evolution over time and wherein steps (I) and (II) are repeated until the melting point measurement determines that the composition has reached the melting point;
wherein in the melting control scheme (Y) the crystallization-change measurement is a melting measurement to determine whether melting of ice has finished in the composition, wherein the crystallization-change temperature evolution over time is a melting temperature evolution over time and wherein steps (I) and (II) are repeated until the melting measurement determines that melting has finished in the composition; and
wherein in the final heating control scheme (Z) the final temperature evolution over time is a final heating temperature evolution over time.

10. The method for thawing a frozen composition according to claim 9, wherein (V) and (W); (V) and (X); (V) and (Y); (V) and (Z); (W) and (X); (W) and (Y); (W) and (Z); (X) and (Y); (X) and (Z); (Y) and (Z); (V), (W) and (X); (V), (W) and (Y); (V), (W) and (Z); (V), (X) and (Y); (V), (X) and (Z); (V), (Y) and (Z); (W), (X) and (Y); (W), (X) and (Z); (W), (Y) and (Z), (X), (Y) and (Z); (V), (W), (X) and (Y); (V), (W), (X) and (Z); (V), (W), (Y) and (Z); (V), (X), (Y) and (Z); (W), (X), (Y) and (Z); or (V), (W), (X), (Y) and (Z) are performed.

11. The method for thawing a frozen composition according to claim 9, wherein the method further comprises rotating the vial at least for a period of time and heating the vial by applying heating gas to the rotating vial.

12. A method for thawing a frozen composition, in particular pharmaceutical compositions, comprising:
storing a quantity of a frozen composition in a vial;
rotating the vial at least for a period of time;
heating the vial by applying heating gas to the rotating vial during rotating of the vial; and
obtaining the composition after thawing is complete.

13. A freezing apparatus for freezing injectable compositions, wherein the freezing apparatus comprises:
a freezing chamber for cooling therein one or more vials, the one or more vials comprising a quantity of a dispersion of an injectable composition in an aqueous dispersion medium, and
a cooling gas system for applying cooling gas to the vial such that the vial is cooled;
wherein the freezing apparatus further comprises:
control means, for controlling the freezing process according to claim 4;
means for measuring the temperature of the vial during at least a certain time of the freezing process,
a control mechanism for influencing the flow rate and/or temperature of the cooling gas, to adjust the cooling rate during at least a part of the freezing process;
or
wherein the freezing apparatus comprises a heat exchange element at least partially surrounding the freezing chamber,
wherein the heat exchange element is in thermal contact with the freezing chamber,
wherein the heating exchange element cools the freezing chamber by using used cooling gas from the freezing chamber or by using another cold fluid or gas;
or
wherein the cooling system comprises a heat exchange element in thermal contact with the gas to be cooled,
wherein the heat exchange element cools the gas by using used cooling gas from the freezing chamber;
or
wherein the cooling gas system comprises a cooling system where the gas is cooled to the cooling temperature;
wherein the cooling system comprises a compressor and a heat exchange element in thermal contact with the gas to be cooled,
wherein the heat exchange element cools the gas by using used cooling gas from the freezing chamber.

14-16. (canceled)

17. The freezing apparatus according to claim 13, wherein the apparatus comprises means for measuring the temperature of the vial during at least a certain time of the freezing process, and
control mechanisms for influencing the flow rate and/or temperature of the cooling gas, to adjust the cooling rate during at least a part of the freezing process.

18. The freezing apparatus according to claim 13, wherein the freezing apparatus further comprises:
rotation means for the one or more vials, wherein the one or more vials can be rotated at least for a period of time to form a dispersion layer at an inner surface of a circumferential wall of the vial, such that the cooling gas system applies cooling gas to the rotating vial such that the vial is cooled.

19. The freeze-drying system for freeze-drying injectable compositions, in particular pharmaceutical compositions, wherein the freeze-drying system comprises:
a freezing apparatus according to claim 13;
an annealing apparatus and/or a sublimation apparatus,
wherein the annealing apparatus and/or the sublimation apparatus comprise a respective annealing chamber and a sublimation chamber,
wherein the annealing apparatus and/or the sublimation apparatus comprise a respective annealing chamber heat exchange element and a sublimation chamber heat exchange element in thermal contact with the annealing chamber and the sublimation chamber respectively,
wherein the annealing/sublimation chamber heat exchange element cools the annealing chamber and/or the sublimation chamber by using the used cooling gas from the freezing chamber or by using another cold liquid or gas.

20. A thawing apparatus for thawing frozen compositions, in particular pharmaceutical compositions, wherein the thawing apparatus comprises:
a thawing chamber comprising rotation means for rotating at least for a period of time one or more vials, wherein the one or more vials for comprising a quantity of a frozen composition in a vial;
and comprising a heating gas system for applying heating gas to the rotating vial during rotating of the vial such that the vial is heated.

21. A thawing apparatus for thawing frozen compositions, in particular pharmaceutical compositions, wherein the thawing apparatus comprises:
a thawing chamber for heating therein one or more vials, wherein the one or more vials for comprising a quantity of a frozen composition in a vial;
and comprising a heating gas system for applying heating gas to the vial such that the vial is heated; and
wherein the thawing apparatus further comprises control means, for
controlling the thawing process according to claim 9;
or
wherein the thawing apparatus comprises a heat exchange element at least partially surrounding the thawing chamber,
wherein the heat exchange element is in thermal contact with the thawing chamber,
wherein the heat exchange element h eats the thawing chamber by using used heating gas from the thawing chamber;
or
wherein the heating gas system comprises a heating system for heating the heating gas,
wherein the heating system comprises a heat exchange element in thermal contact with the gas to be heated,
wherein the heat exchange element heats the gas by using used heating gas from the thawing chamber.

22-23. (canceled)

24. The thawing apparatus according to claim 21, wherein the thawing chamber comprises rotation means for rotating at least for a period of time the one or more vials; and wherein the thawing apparatus comprises a heating gas system for applying heating gas to the rotating vial such that the vial is heated.
